(19) United States
(12) Patent Application Publication
(10) Pub. No.: US 2011/0033830 A1
(43) Pub. Date: Feb. 10, 2011

(54) CTS PEP PREVENTION EDUCATIONAL PRODUCTS

(76) Inventor: GABE CHERIAN, Sun Valley, ID (US)

Correspondence Address: GABE CHERIAN, P.O. BOX 1335, SUN VALLEY, ID, 83353, US

(21) Appl. No.: 12/538,137

(22) Filed: Aug. 8, 2009

(51) Int. Cl. G09B 19/00

(52) U.S. Cl. 434/236

(57) ABSTRACT

Carpal Tunnel Syndrome (CTS) and Cumulative Trauma Disorders (CTD's, also known by other names such as repetitive stress injuries [RSI's] and other such names, have emerged as a significant occupational health problem. The present invention is to provide systems, devices, products, methods and software programs, which will remind individuals, such as keyboard operators, on a regularly scheduled basis, and to recommend certain preventive exercises and the like. Once the system and the software is designed and implemented, a study will then be instituted to measure its effectiveness in workplaces, especially those that have experienced a high incidence of problems such as carpal tunnel syndrome. The recommendations for specific actions, such as posture and exercises, will be based on work already established in the medical and occupational literature and journals, as well as the continuous research conducted by medical experts in the field. The development of a relatively inexpensive method of controlling, reducing and preventing the incidence of these disorders is important to prevent injuries and to save money on insurance premiums, payments to injured workers, loss of productivity, loss of productive workers from the workplace as well as the need to retrain injured workers. Furthermore, the invention relates to an electronic device or chip that would act as the heart of the above system, and could be used as an embedded chip in various products.

### CROSS-REFERENCE TO RELATED APPLICATIONS

Not Applicable

### STATEMENT REGARDING FEDERALLY SPONSORED RESEARCH OR DEVELOPMENT

Not Applicable

### BACKGROUND

1. Field of the Invention

The invention relates to health issues, and more specifically to health problems resulting from engaging in repetitive actions, like Carpal Tunnel Syndrome and the like, as well as to opposite cases, i.e. to cases related to the effects of the lack of movement or to sedentary life styles. The invention relates to systems, devices, products, methods and programs that would monitor the activities of individuals or track their behaviour, especially when such activities are repeated periodically and could have a detrimental effect on the individual's health if such activities are continued for extended lengths of time. The invention then provides guidance and instructions to alter the individual's activities so as to reduce the risk of contracting the potential bad effects or hazards of the original activities. In essence, the invention provides “Prevention Educational Products” (PEP) and/or instructions, because it includes several products, each of them comprising a program that would educate and encourage the users to do certain things that could prevent the bad effects of certain behaviour from happening.

The core of the invention relates to a system and/or methods that
1) monitors an activity of an individual,
2) compares it against certain norms and/or limits,
3) determines whether the monitored activity has reached or exceeded these limits, and
4) if so, then the system recommends and encourages the individual to do certain preventive or protective actions, which are expected to reduce the risk of contracting certain undesirable effects, if the original activities would continue unchecked or unchanged.
   i.e. the system: monitors, compares, decides, encourages or educates.

It could also be referred to as a Smart or PEP Health Monitor System.

Furthermore, the invention relates to an electronic device or chip that would act as the heart of the above system, and could be called an embedded chip. This chip would be programmed, by a software or firmware program, which would do the above four steps and more as needed. The chip could contain several sub-components and would be programmed to do most of the functions listed above and beyond.

More yet, the invention relates to the methods that are required and used to implement and operate the above systems and products.

2. Abstract re CTS/CTD & Related Art

Carpal Tunnel Syndrome (CTS) and Cumulative Trauma Disorders (CTD's, also known by other names such as repetitive stress injuries [RSI's] and other such names, see the list in the “Definition” section of this specification), have emerged as a significant occupational health problem to the extent that, to my understanding, at one time, the Federal Government has mandated that workplaces put methods in place to control/prevent them. [Verify whether this is still so, now]

One main objective of the present invention is to provide systems, devices, products, methods and software programs, which will remind individuals, such as keyboard operators, on a regularly scheduled basis, to be sure to use the correct posture, to take periodic breaks, to rotate activities; as well as to do specific actions, such as preventive exercises. Once the system and the software is designed and implemented, a study will then be instituted to measure its effectiveness in workplaces, especially those that have experienced a high incidence of problems such as carpal tunnel syndrome.

The recommendations for specific actions, such as posture and exercises, will be based on work already established in the medical and occupational literature and journals, as well as the continuous research conducted by medical experts in the field. The development of a relatively inexpensive method of controlling/reducing/preventing the incidence of these disorders is important to prevent injuries and to save money on insurance premiums, payments to injured workers, loss of productivity, loss of productive workers from the workplace as well as the need to retrain injured workers.

This could be another one of the building blocks that could improve the health care of the nation.

One of the basic functions of the proposed approach could be considered to be based on an “Inverse” Screen Saver” or “Reverse Screen Saver” or “RSS” approach,

The invention will basically provide Educational and Encouragement Products with an appropriate Program, and would show recommended exercises, at predefined time intervals, for the main purpose of reducing the Pain & Suffering of Employees and of Reducing Employers' Disability Insurance costs and premiums. The program could also include “General or Public Announcements” or “Encouraging Remarks” from the Employers, “Commercial Messages”, etc.

The approach can be used especially by Large Size Employers, Nationwide or even Worldwide

### Other Similar Health Related Problems

CTS is only one of the issues addressed by this invention, specifically by embodiment #1. The invention extends the concept mentioned above as it relates to Carpal Tunnel Syndrome, and applies it to other situations or cases that can benefit from utilizing the same or a similar approach. The following are examples of such situations or cases, and are covered by the respective embodiments, as described later on in the present invention specification. Other applications can be envisioned as well, simply by applying the principles described in the present application here:

Embodiment #2: A road construction operator works for hours on end, operating a motorized jack hammer. Solution: the Smart or PEP Glove.

Embodiment #3: An athlete gets on the treadmill trying to improve his/her endurance or general physical abilities, and may overdo it and could hurt him/herself. Solution: the Smart or PEP chest heart rate strap or Smart or PEP wrist heart rate monitor, together with the PEP watch, or PEP pager, or even the PEP cell phone or PEP PDA. The wrist watch can have a switchable readout, that can alternate from time reading to act as a watch for CTS and the like, and could be called a Health Monitor Watch, or simply the PEP Wrist Watch. Wrist watch to beep at the required time setting. Setting like any digital watch.

Embodiment #4: A hiker keeps on walking for hours on end and gets dehydrated. Solution: the Smart or PEP Pedometer, the Smart or PEP Water Bottle, the Smart or PEP Wrist Watch, the Smart or PEP Cell Phone.

Embodiment #5: A biker keeps on pedaling for hours on end and also gets dehydrated and his/her muscles and other parts of his/her body may get overstressed and fatigued. Solution: the Smart or PEP Speedometer, the Smart or PEP Bike Seat, the Smart or PEP Handle Bar, the Smart or PEP Pedals, and again the Smart or PEP Water Bottle, the Smart or PEP Wrist Watch, the Smart or PEP Cell Phone.

Embodiment #6: An office employee or computer operator can sit on an office chair and “slouch” and as a result, he/she could hurt his/her back and get fatigued in a relatively short period of time. Solution: the Smart or the PEP Office Chair/Seat

Embodiment #7: A sedentary person watches television for hours on end, and many of his joints “gets stiff” and suffers from arthritis and the like. Solution: the Smart or PEP Easy Chair or the Smart or PEP Sofa.

Embodiment #8: A patient in a hospital lies in bed for hours or days on end without moving and gets bed sores or his/her arthritis etc may hurt him/her more. Solution: the Smart or PEP Bed.

Etc.

These and other similar devices, systems and programs will also be described in this specification, as additional embodiments of the inventions.

The CTS system will be described at length and then the other embodiments will refer to many of the features of the CTS system and could use similar features and approaches, but will also describe the special features of each particular embodiment respectfully.

### BRIEF SUMMARY OF THE INVENTION

The invention covers several embodiments.

One embodiment provides a monitoring and alerting and prevention educational system, with appropriate programs, devices and methods, wherein the system “watches” the activities of an individual and senses and measures the activities and determines the length of time and other elements of such activities, and predicts their effects and potential resulting hazards. If and when the duration and other elements of the activity gets too long or excessive, or the intensity of these activities gets too high, or the combination of the duration and intensity, reach or exceed certain preset predetermined levels or limits or thresholds, then the system would issue an alert or a warning of some sort, informing the individual about that fact. The system could also suggest certain changes of behaviour, such as taking a rest or break period, doing certain exercises, drinking some water, or the like.

The individual may opt to interrupt the original activity and/or change his pace or the intensity of his efforts; or the individual can simply ignore the warning and/or override the instructions. In some embodiments, the system could provide the individual with some guidance or instructions, which could result in reducing the potential unfavourable/undesirable/detrimental effects of continuing the activity, especially the long term effects of the activity. These instructions could include telling the individual to take a break for a certain time duration, or to do certain physical exercises, like stretching or flexing exercises or therapeutic movements which could lower the stresses on the individual, resulting from these activities.

The monitored activities could include any one or more of the following groups: a) doing light weight work, e.g. working on the computer and typing on the keyboard, but for extended periods of time; b) doing almost sedentary activities even without the exertion of any strenuous physical effort, e.g. simply sitting in a certain position for extended periods of time, like when working at the computer or driving a car or even simply watching television; c) doing heavy duty work, e.g. working with a motorized jack hammer.

Notes:

Other variations of the above embodiment are easily conceivable. A few of them are described later below.

The recommended exercises, etc. could be stored in the program or at an external source/location, e.g. a central IP server; and are presented to the operator on the computer screen.

The effect of using the system and the program will not be noticed immediately, but over the long run. It is expected and hoped that over the long term, it will be statistically obvious that there will be less cases of the dreaded carpal tunnel syndrome.

### DEFINITION NOTES

### Abbreviations & Legend for the Specification, Project Outline, Project Costs, and Business Plan

PEP=Prevention Educational Products

PEP=Prevention Educational Program

PEP=Prevention Encouragement Products

PEP=Prevention Encouragement Program

PEP=Preventive Educational Products

PEP=Preventive Educational Program

PEP=Preventive Encouragement Products

PEP=Preventive Encouragement Program

PEP=Protection Educational Products

PEP=Protection Educational Program

PEP=Protection Encouragement Products

PEP=Protection Encouragement Program

PEP=Protective Educational Products

PEP=Protective Educational Program

PEP=Protective Encouragement Products

PEP=Protective Encouragement Program

CEO=Chief Executive Officer

CFO=Chief Financial Officer

CLO=Chief Legal Officer/Counselor

CMO=Chief Marketing Officer

CPU=Central Processing Unit (usually of a computer)

CTO=Chief Technical Officer

Gabe=The Inventor

MB=Member(s) of the Medical Board

Patent Attorney=CLO or Substitute

PROG=Programmer=CTO or Substitute

VC=Member(s) of the Venture Capital Contributors

Some of the Sources:

http://whatis.techtarget.com/definition/0,,sid9_gci213872,00.html

http://en.wikipedia.org/wiki/Tendinitis

http://www.google.com/search?q=carpal+tunnel+syndrome+symptoms&ie=utf-8&oe=utf-8&aq=t&rls=org.mozilla:en-US:official&client=firefox-a

Trademarks of third parties:

Bluetooth® is a registered trademark of Bluetooth Special Interest Group (SIG), www.bluetooth.com.

Wi-Fi (IPA: /‘wa [symbol] fai/) [as per Wikipedia] is the trade name for a popular wireless technology used in home networks, mobile phones, video games and more. Wi-Fi is supported by nearly every modern personal computer operating system and most advanced game consoles, printers, and other peripherals.

### DEFINITIONS

Achilles tendinitis. See Tendonitis.

Bone spur. See Tendonitis.

CTD Cumulative Trauma Syndrome;

CTD cumulative trauma disorder—In information technology, cumulative trauma disorder (CTD) refers to any of several physical problems that can result from improper or excessive use of a computer display or terminal. Other terms for repetitive stress disorders are repetitive stress injury (RSI) and repetitive motion disorder (RMD). Perhaps the most well-known CTD is carpal tunnel syndrome. In occupations involving long hours of keyboard use over a period of years, the tissue in the wrist can become chronically inflamed and swollen. In severe cases, scarring occurs. The main nerve leading from the arm into the hand becomes pinched. The result is arthritis-like pain and stiffness in the hand and fingers. If not treated, the condition can progress until keyboard use becomes impossible. Proper hand positioning, and the use of wrist supports, can minimize the risk that a computer user will develop this syndrome. Poor posture, caused by improper chair height, a desk that is too high or low, or a display too far below eye level, can bring about back pain and spasms. In severe cases, the condition can be disabling, and its cause can be mistaken for an organic illness such as kidney disease. Pain and stiffness may also occur in the legs, neck, and shoulders. The problem can usually be corrected by paying careful attention to ergonomic aspects of the computer or workstation.

CTS Carpal tunnel syndrome (CTS) or median neuropathy at the wrist is a medical condition in which the median nerve is compressed at the wrist, leading to pain, paresthesias, and muscle weakness in the forearm and hand.^{[1] A form of compressive neuropathy, CTS is more common in women than it is in men and has a peak incidence around age} 42, though it can occur at any age.^{[2]} The lifetime risk for CTS is around 10% of the adult population.^{[3]} Most cases of CTS are idiopathic (without known cause). Repetitive activities are often blamed for the development of CTS along with several other possible causes. However, the correlation is often unclear. It is a multi-faceted problem and can therefore be challenging to treat. Still, there is a multitude of possible treatments: treating any possible underlying disease or condition, immobilizing braces, osteopathy, physiotherapy, chiropractic, massage therapy, medication, prioritizing hand activities, ergonomics. Ultimately, carpal tunnel release surgery may be required in which outcomes are generally good. The condition was first noted in medical literature in the early 20th century.

CTS carpal tunnel syndrome is the most well-known CTD cumulative trauma disorder—See CTD.

CUBITAL TUNNEL SYNDROME;

ELBOW TENDINITIS ME/LE Medial Epicondylitis & Lateral Epicondylitis;

ERC External Rotator Cuff Syndrome,

Golfer's elbow. See Tendonitis.

Iliotibial band syndrome. See Tendonitis.

### LHBT Long Head of the Biceps Tendinitis;

Metatarsalgia. See Tendonitis.

O.S. Overuse Syndrome;

Patellar tendinitis. See Tendonitis.

RMD Repetitive Motion Disorder—See CTD.

RSI Repetitive Stress Injury—See CTD.

RSS Repetitive Stress Syndrome

RSS Repetitive Stress Syndrome;

Stenosing tenosynovitis

T.O. Thoracic Outlet Syndrome;

Tendinitis Tendinitis or tendonitis (from the Greek Tενoντíτiç, ‘itis’ denoting inflammation or swelling) used to be thought of as a painful inflammation of a tendon, however, there is rarely much inflammation associated with the condition, thus ‘tendinitis’ is an inaccurate term, ‘tendinopathy’ being currently used. More recent research indicates that tendinopathy is an overuse injury resulting in microtears in the muscle fibres, leading to an increase in tendon repair cells, yet an absence of inflammatory cells. This may lead to reduced tensile strength, thus increasing the risk of tendon rupture. Generally tendinitis is referred to by the body part involved, such as Achilles tendinitis (affecting the Achilles tendon), or patellar tendinitis (jumper's knee, affecting the patellar tendon). Chronic overuse of tendons leads to microscopic tears within the collagen matrix, which gradually weakens the tissue. Diagnosis: Swelling in a region of micro damage or partial tear can be detected visually or by touch. Increased water content and disorganized collagen matrix in tendon lesions may be detected by ultrasonography or magnetic resonance imaging. Symptoms can vary from an ache or pain and stiffness to the local area of the tendon, or a burning that surrounds the whole joint around the inflamed tendon. With this condition, the pain is usually worse during and after activity, and the tendon and joint area can become stiffer the following day as swelling impinges on the movement of the tendon. Many patients report stressful situations in their life in correlation with the beginnings of pain which may contribute to the symptoms. Common tendonitis injuries: Tendinous injuries are common in the upper and lower limbs (including the rotator cuff attachments), and are less common in the hips and torso. Individual variation in frequency and severity of tendinitis will vary depending on the type, frequency and severity of exercise or use; for example, rock climbers tend to develop tendinitis in their fingers, swimmers in their shoulders. Achilles tendinitis is a common injury, particularly in sports that involve lunging and jumping while Patellar tendinitis is a common among basketball and volleyball players owing to the amount of jumping and landing.^{[24] A veterinary equivalent to Achilles tendinitis is bowed tendon, tendinitis of the superficial digital flexor tendon of the horse.}

Tendinitis of the Shoulder;

Tendinitis. See Tendonitis.

Tennis elbow. See Tendonitis.

Tenosynovitis. See Tendonitis.

Tension Myositis Syndrome. See Tendonitis.

Ulnar Canal de Guyon Syndrome;

WRIST TENDINITIS; See tendinitis in general, and as applied to wrist.

### BRIEF DESCRIPTION OF THE DRAWINGS

FIGS. 1 through 12 show an example of windows screens of a computer program. The program monitors the length of time, that an individual has been working on a computer; and at the proper time, the system would tell the individual to stop working on the computer and to take a rest, and then allows the operator to go back to work. And then the system repeats the whole cycle, over and over again. During the break time, the program may suggest certain exercises, that the operator could follow, as shown.

FIG. 1 is the initiation of the system's program, i.e. the opening dialog box. The program is ready to do its job.

FIG. 2 is shows the beginning of monitoring the “work time”.

FIG. 3 shows the beginning of the “Rest or Break Period”.

FIGS. 4 through 7 show some of the suggested exercises that the system would provide to the computer user/operator, which are exercises that would be done during the Break Period. See further below for the various available options. Music or voice instructions could be added.

FIG. 8 shows when the system tells the user/operator that the break period is over and that it is time to go back to work. An audible sound alarm or music may accompany this screen. Actually, all the screens could also have such audible sound or music. Optional.

FIG. 9 shows the screen that tells the operator to stop working again and to take a second break period.

FIGS. 10 and 11 show another set of suggested exercises that the system could provide to the user/operator, exercises that would be done during this second Break Period. These exercises can be the same as those suggested for the first break period or can be a different set of exercises. The choice of varying the exercises and the kinds of exercises would be pre-determined by the settings of the system's program. Again, see below for these and other options.

FIG. 12 is a second call to go back to work, this time at the end of the second break period. Again, an audible sound alarm or music may accompany this screen.

FIGS. 13 through 27 show sample of various instructions and exercises which can be provided by the system to the operator.

FIGS. 28 through 30 show a flow chart for a software program that illustrates the major steps carried out by one embodiment of the present invention.

FIG. 31 shows an arrangement where several computers are attached to a network. Some computers could have their CTS program installed in each of them individually, while others would have that program provided to them from the central IT server. Some cold be wired directly while other could work by wireless.

FIGS. 32 and 33 show a motorized jackhammer at work and a PEP Glove embodiment.

FIG. 34 shows an athlete working out on a treadmill, and carrying several other embodiments of the invention: a PEP Heart Rate Strap, a PEP Wrist Watch and a PEP Pager or PEP Cell Phone.

FIG. 35 shows a hiker, or a biker for that matter, carrying a backpack, which holds a water bag. The backpack has a PEP Pedometer, the water bag has a water level sensor, and the whole system has all the necessary components to act as a PEP Water Bag or a PEP Backpack.

FIGS. 36 and 37 show a bicycle equipped with several PEP Gadgets, including a PEP Seat, a PEP Water Bottle with a PEP Water Nipple with a PEP Nipple Cover, a PEP Speedometer, PEP bike handle Grips, PEP bike Pedals. The PEP Speedometer Readout can have a number of button to switch the readings from the regular prior art kind of readings, to all the various PEP readings that are part of the PEP Program and Software, and to control the audible warnings and alerts, etc. The water nipple cover could be for sanitary and/or cosmetic purposes. The cover could have segments that could be opened or closed, e.g. like the petals of a flower.

FIGS. 38 through 40 show a computer operator sitting on an office chair. In the first two figures, the correct and incorrect postures are shown, and in the third figure, some exercises are shown. The office chair could be instrumented to become a PEP Office Chair, similar to the other embodiments listed herein.

FIGS. 41 and 42 show a PEP Easy Chair (or PEP Sofa), together with a PEP wrist watch, a PEP Belt Box, a PEP Pocket Box in FIG. 41, and the sensing and control elements of a PEP Chair in FIG. 42.

FIGS. 43 through 45 show a PEP Bed, with its X-Y matrix of sensors and actuators. The actuators could be mechanical, pneumatic, hydraulic or the like.

FIGS. 46 and 47 show an additional “massage” feature that can be added to the PEP Chair or PEP Bed, shown earlier.

FIG. 48 shows a block diagram of a PEP Chip with a built-in PEP Sensor, PEP software/firmware, and ancillary components. It can either work on self-generated power from the sensor itself, or from a built in battery cell, or from an external power source. It would have proper terminals and/or interconnection means, e.g. contact pads, to load the software/firmware program into it, and for external power input, and it would have means to send its signals, either by wired or by wireless communication means. It can be made of several discrete components or could be self contained and can be made small enough to be able to be inserted in all kinds of gadgets, to impart to them the features and capabilities of the PEP Program as per present invention.

### DETAILED DESCRIPTION OF THE INVENTION AND OF THE DRAWINGS

The individual drawings and figures will be described in more details during the process of describing the invention and the various embodiments thereof.

1. Embodiment #1: The “Reverse Screen Saver” (RSS)

This embodiment will be described in great details, to establish a base of the invention technology, which will be used later to help in the description of the other embodiments.

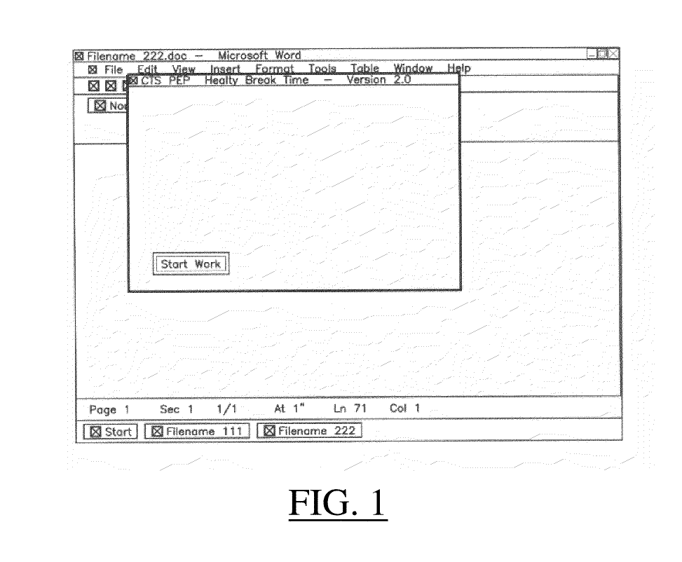

FIGS. 1 through 12 show the major direct visible results of one embodiment of the invention. This embodiment will be referred to as the PEP CTS “Reverse Screen Saver” or the PEP CTS RSS, or simply the RSS.

The conventional screen savers that are presently on the Market are well known. I consider them and will refer to them as the “Prior Art Screen Savers”. They monitor the activity on the computer, to determine the “idle time” of the monitor and/or of the computer, and when that idle time reaches a preset pre-determined length of time, then the screen saver program kicks in and switches the image on the monitor and puts on the monitor a “moving” set of images. The main purpose of any such prior art screen saver of the prior art is to prevent damaging the sensitive elements of the computer, mostly the monitor screen. Because if the image stays in one position for an appreciably extended length of time, the sensitive coatings/layers of the monitor could get damaged.

In the simplest form of the Reverse Screen Saver (RSS) embodiment of the present invention, we use a program, similar to the “monitoring/sensing” portion of the conventional prior art screen savers program, but we use it in effect in reverse, i.e. for the opposite reason, as will be explained here below.

The RSS monitors the “active time” of the computer/operator. This is the “reverse” of what happens with the prior art screen saver. The prior art screen saver monitors and watches the “idle” time, but in our case, we monitor and watch the “active” time. So, in our case, when the active time reaches a preset pre-determined length of time, then our reverse screen saver program switches the computer to what we will refer to as the “break period”.

In addition, the RSS will optionally provide certain suggestions to the operator, to do certain exercises during this break period, which exercises are intended to help in preventing, or at least reducing the risks of, contracting carpal tunnel syndrome or similar ill effects of working too long on the computer.

Later on below, we will show how similar things will be provided in the other embodiments of the present invention, to address the ill effects of doing the opposite kind of activities, like remaining idle and in one position and/or doing nothing, for long periods of time. Examples of such situations are: a) driving a car or truck long distances, without stopping and without getting out of the car and stretching or even without re-adjusting your seating position; b) sitting too long in one position in front of the computer or watching television, etc. The ill effects of doing that is that you “become stiff”, as the term goes; c) lying in bed for long periods of time, say after a surgery, and getting bed sores.

In this RSS embodiment, an individual working on a computer, referred to hereinafter as an operator, using the keyboard or a mouse or other such interface devices, is monitored by the system and its program to determine the length of time the operator works on the computer and/or the intensity of his activities. When the operator has worked for a certain length of time, referred to as the “active work period”, or simply the “work period”, the length of which would be pre-determined and preset by the system and/or the person deciding these matters, herein after referred to as the “system administrator”, then the system would initiate a series of events as described below and as illustrated by FIGS. 1 through 12. The length of time of the work period and the break period as well as the suggested exercises would be based on recommendations of medical experts and other persons well versed in the appropriate scientific fields.

Again, in its simplest form, the system will alert the operator to take a rest or break period. In some more elaborate versions of this embodiment, the system would also provide the operator with some suggestions as to certain exercises that the operator would or could do, to help in preventing or at least reducing the risks that the operator would contract carpal tunnel syndrome. The operator may opt to follow the suggested exercises or ignore them and do something else during the break period or to “override” the instructions and continue to work. At the end of the break period, the length of which would also be preset and predetermined by the system administrator, the system would stop the break or exercise period, and would suggest to the operator that it is time to go back to work. The operator may opt to go back to work immediately or may opt to do other things before resuming the work. The system resumes and starts to count the active work time again and repeats the whole process sequence just described, over and over again.

FIGS. 1 through 12 show an example of the above “Reverse Screen Saver” (RSS) embodiment of the present invention

They show an example of a computer program, which monitors the length of time, during which an individual has been working on a computer and then, at a certain moment in time, the system would tell the individual to stop working on the computer and to take a rest or break period.

During the break period, the system would encourage the individual to do some exercises that could help in preventing some unfavourable effect of working for extended length of time on the computer. At the end of another pre-determined length of time of the break period, the system would encourage the individual to resume work if he/she so desires.

FIG. 1 shows the opening dialog box screen that shows that the system is operational and ready to do its job. The operator would click on the button that reads “Start Work”, and the system will take over. This screen could also be used to show “announcements” or “news flashes” or “encouraging remarks” from the employer.

This FIG. 1 screen is optional. The system can be programmed so that the system would start automatically once the computer is turned on, or once the operator logs on or starts using the keyboard, or the like. In such cases, either the operator would just click on “start”, or the system would start the program by itself, when the operator starts to work on the computer.

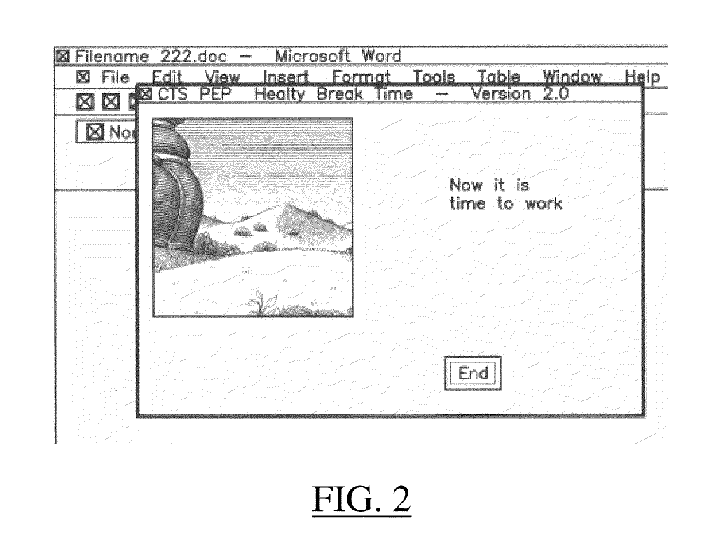

FIG. 2 shows a dialog box that tells the operator that the system is working and that the system will start monitoring his/her activity on the computer, i.e. the performance monitoring process. It tells the operator that it is OK to start or to precede with his/her work on the computer, until the next instruction shows up on the screen. The screen in FIG. 2 also has an “End” button, which allows the operator to stop the program and the system would then discontinue monitoring the operator and his/her activities.

One option of the whole system is the ability of recording, in a history log book/file, all the actions of the operator with respect to this program. So, if it becomes obvious that this system is really helpful in reducing the risks of contracting carpal tunnel syndrome, then some employers may opt to make it mandatory that the employees follow the instructions of the system, and to take the breaks and to do the suggested exercises. If this is the case, and if the employee chooses to ignore the recommendations of the system and/or to “over-ride” the system, then the system would record such behaviour in a history log file, so that the employer could refer to that history log file in the future. This history log file could be stored either inside the computer itself and/or it can also be stored in a central location, such as the central IT server if the computer is connected to such a server.

In the other embodiments that will be described later, the system would have the capability of sending any of the data and process steps, by wired or by wireless means to remote monitoring locations, for the purpose of monitoring the activities of the person or for providing emergency help whenever it is needed. It could also record the activity on an internal memory area of the system.

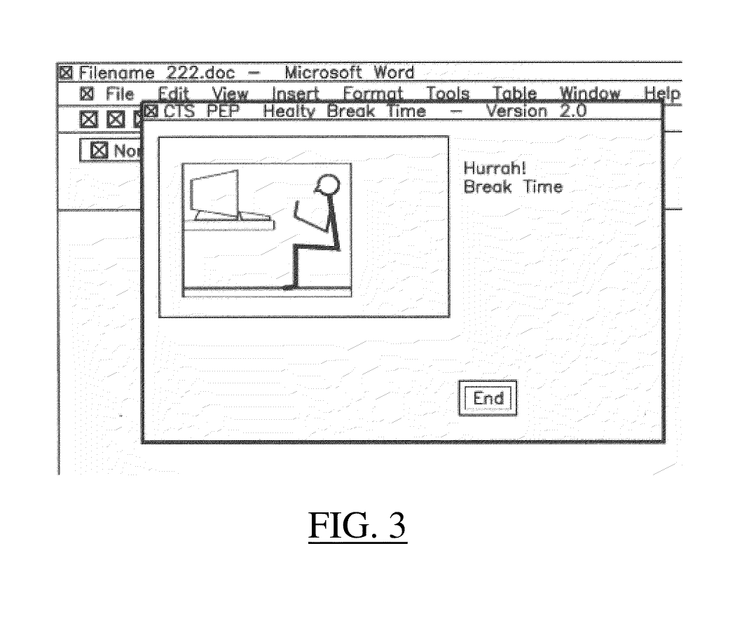

FIG. 3 shows what will happen after a pre-determined length of “working” time has elapsed, i.e. at the end of the “Work Period”. The screen could show a short comment, like “Hurrah! Break Time”, indicating that now the operator should take a break and rest.

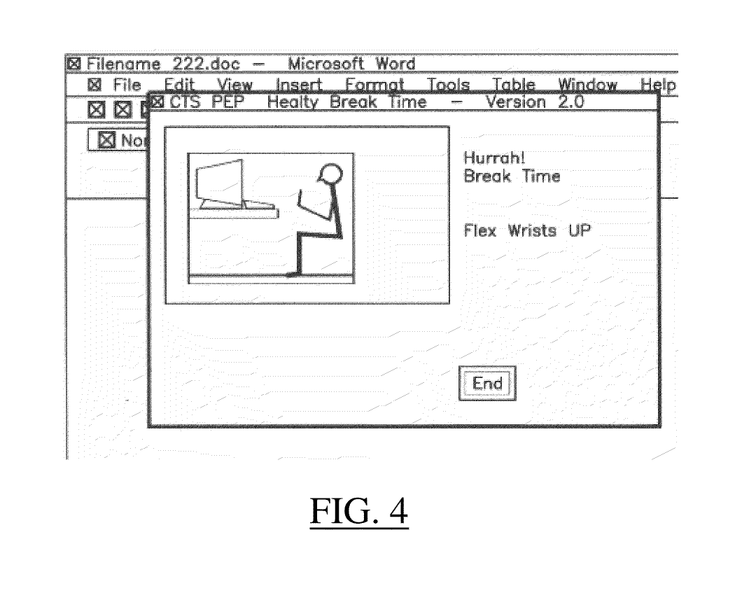

FIG. 4 shows one of the exercises that could be suggested by the system. The system will provide the operator with some suggested “therapeutic exercises” and text explanations of what to do. These exercises would be intended to counteract the ill effects of what the operator has been doing during the work period. There could also be some voice instructions and even some music, to further guide and encourage the operator to follow the exercises.

The suggested exercises could be selected by a team of specialists, e.g. physicians, trained and experienced in the applicable field, who would select a number of such exercises, which will be most suitable to the specific situation or application, i.e. for the specific type of activity carried on in that specific situation. The exercises can be selected based on the available published studies and articles on the subject, or based on our own research findings, or on a combination of both. The exercises suggested for a computer operator would be different than the exercises suggested for a driver of an automobile or a truck, and these will be different than the exercises suggested to a person sitting and watching television for a long period of time.

In this specific example shown in FIG. 4, the exercise is to flex the hands at the wrist, upwards. The accompanying text reads “Flex Wrist Up”. Again, the screen shows the “End” button, as explained above.

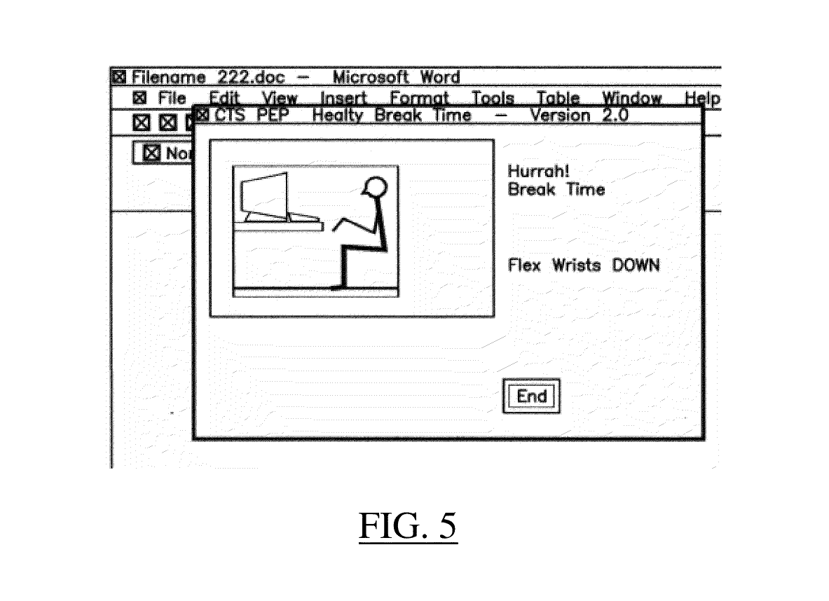

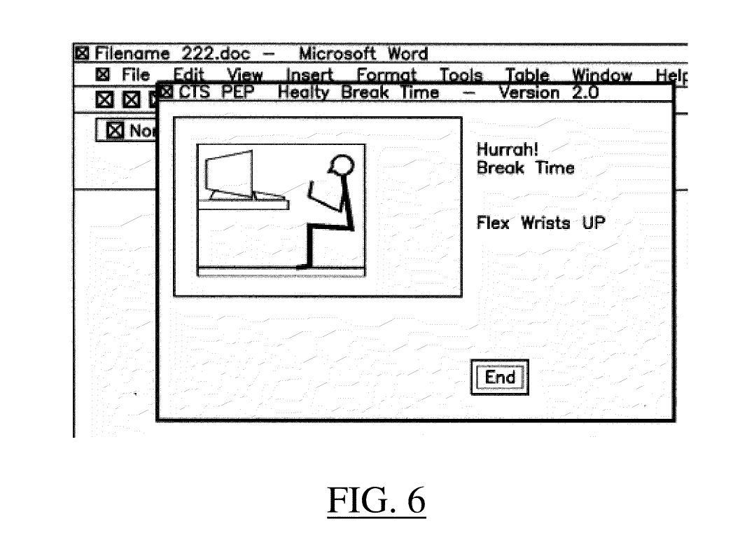

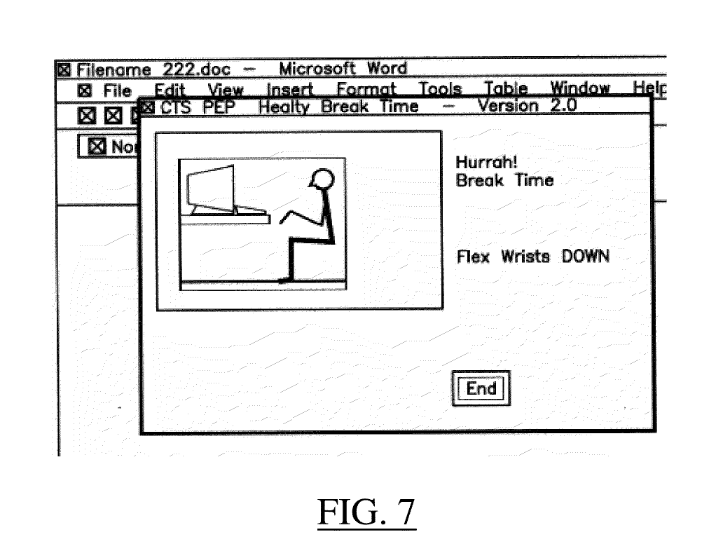

FIG. 5 shows the next step in the above exercise routine, which was started in FIG. 4. This time, it says “Flex Wrists Down”. And the picture in the screen shows what to do. This sequence of “Flex Wrist Up” and “Flex Wrists Down” may repeat for several seconds, as in FIGS. 6 and 7, depending on the settings of the program. Also a voice instruction and/or music may accompany the pictures or drawings.

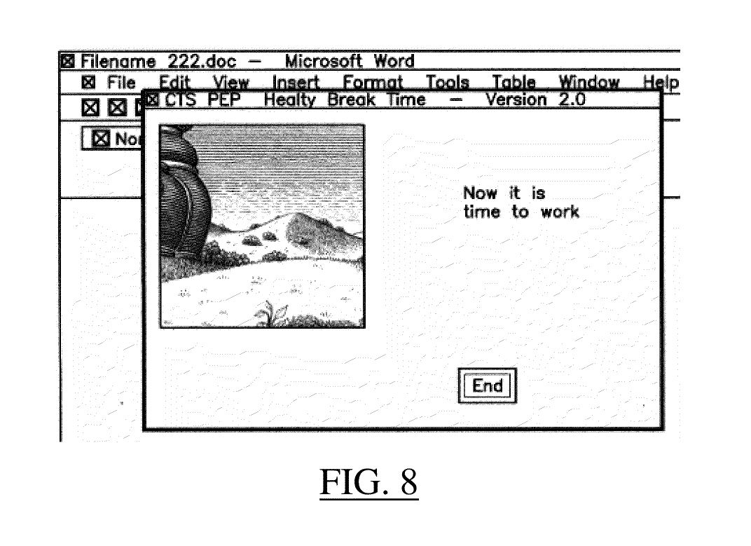

FIG. 8 shows a screen that would appear at the end of this exercise session. It reads “Now it is time to work”, or some words to that extent. It can show any number of pictures like the one shown in this example or any other appropriate pictures. It could also contain some encouraging words from the employer company and/or some advertisements or the like.

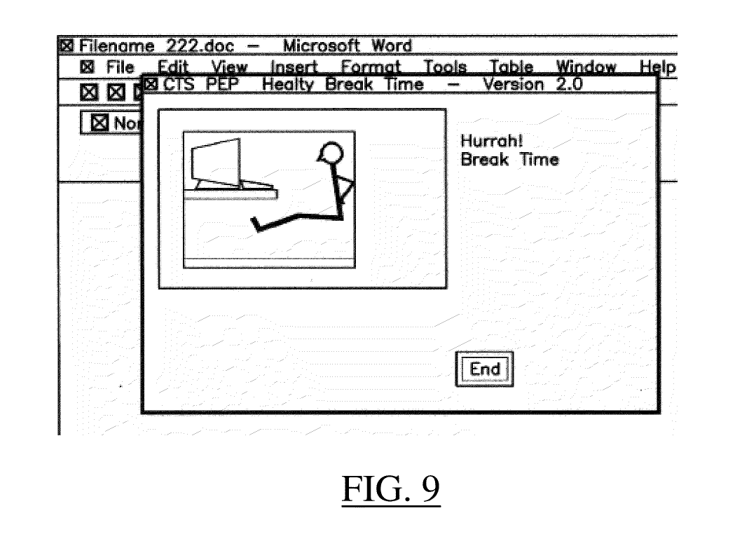

FIG. 9 shows a screen alerting the operator to take the next break period.

After the operator has resumed work, subsequent to the screen shown in FIG. 8, and after the operator has worked on the computer for some time, equivalent to the pre-determined or pre-specified “work period”, the system would automatically open a screen as in FIG. 9, which is similar to the one shown in this FIG. 3, and suggests to take this new break period. The work period could be based purely on the “elapsed length of work time”, or could be based on the “intensity” of the work performed, or on a “combination” of time and intensity. Other factors could also be considered as experience with using the program may show.

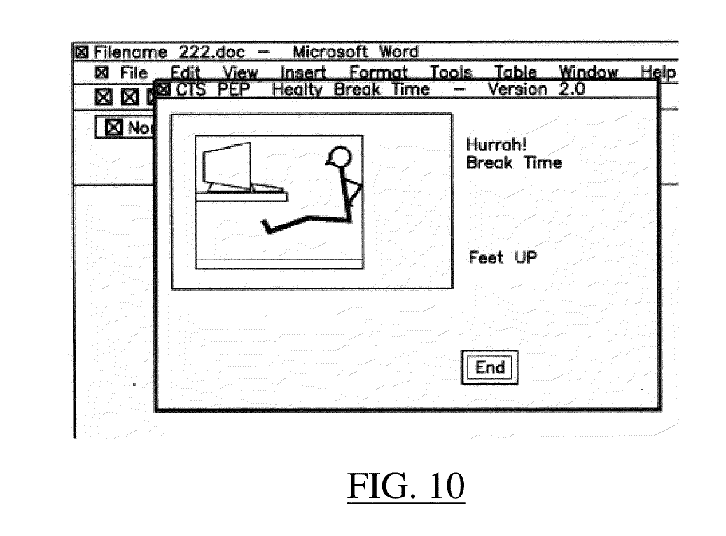

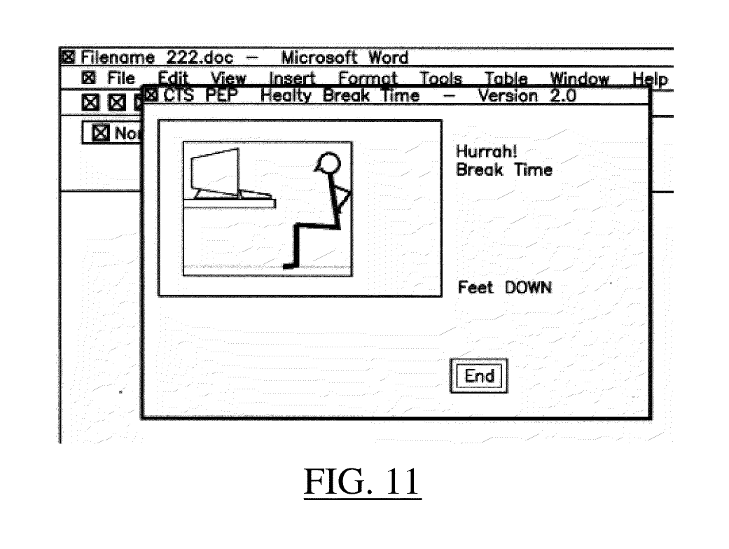

FIGS. 10 and 11 show a set of screens which recommend to the operator to do some more exercises. These can be the same exercises suggested earlier as in FIGS. 4 through 7, or they can be a different set of exercises as in these FIGS. 10 and 11. In FIG. 10 the exercise is to raise the feet up. The accompanying text reads “Feet Up”. FIG. 11 shows a screen with the “Feet Down”. Again, these exercises may be repeated for several seconds, depending on the settings of the program.

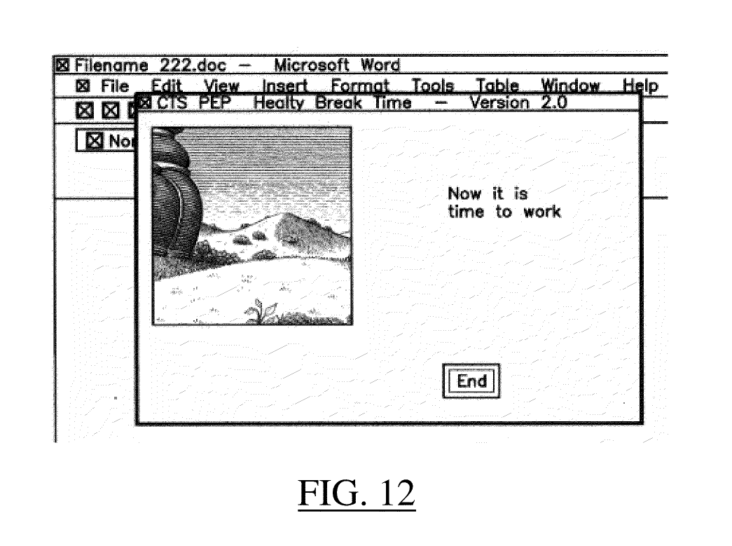

FIG. 12 shows a screen that would appear at the end of these exercises of the second break period. It is a screen, similar to the one in FIG. 8, allowing or encouraging the operator to resume work.

After that, the whole cycle would keep on repeating, over and over again, until the end of the work day, or for the lunch break, or until the operator “ends” the cycles and shuts down the RSS monitoring system.

The RSS system would also shut down automatically, when the computer is shut down, either by itself or by the operator.

Options, Settings and Variations of this Embodiment

A large number of options are available, leading to various settings to the system and to variations in the embodiments.

Here below are some examples of such options, settings and variations:

1. Stand-alone computer versus Computers on a Network:

a) The computer can be a stand alone computer, not connected to any outside system or network. The system's software program would be installed in this computer and the settings will all be entered in this computer. The “history log file” would be saved inside the same computer or it can be eliminated or disabled all together, if so desired. The purpose of such an installation would be solely for the benefit of the operator and will be under the operator's control and his/her decisions, or

b) The computer could be connected to a network, either to a local network, or to the IT Centre of the employer, or to a large scope network, such as the Internet World Wide Web. In this case, the system program/software can either be installed on the individual computer, or can be provided through the network. In this case, the history log file can again be kept either in the computer itself and/or can be kept at a remote location within the network. The system or the network administrator can choose to set these options on each computer in a different way, or can have different groups of computers set in one way, while other sets of computers would have different settings.

2. The Software Program and its Packaging and Connectivity:

The software used to run and control the system will be available in a number of formats, at least the following ones:

a) It can be stored on a CD disk or similar memory devices or the like and installed on individual computers for the use and benefits of the individual operators, or

b) It can be packaged so that it would be installed in a central computer/server, say at the IT centre of the employer, and then the individual satellite computers attached to the IT Centre would use the program, simply by being attached to the IT Centre Server. This could be the case with a relatively large company and would allow the company to monitor the behaviour of the employees and especially to record whether they are adhering to the recommended routines and collect statistics if so desired. The company could purchase a site license, whose price would depend on the size of the company, proportional to the number of employees using the system, or

c) The program can be provided on the Internet, say as a free trial download, or as a one time paid subscription, or as a monthly or annual subscription, like the Norton Symantec Anti-Virus approach.

3. Audible Sounds, Alarms, Bells, Music, Voice:

a) An audible sound alarm or music can accompany some or all of the screens shown in FIGS. 1 through 12. For example, in FIG. 3 to start a break period, or in FIG. 8, when the system tells the operator that the break period is over and that it is time to go back to work, a bell sound can be generated to emphasize the point.

b) Similarly, with each of the exercise movements, as in FIGS. 4 through 7 or FIGS. 10 and 11, a bell sound can be produced to encourage keeping the pace, or for the “timing”, of the exercises, almost like a chronometer.

c) A “coaching” voice can be added to the exercises, either to explain the exercises and the movements, or to simply encourage the operator to join in.

d) Some music can accompany the exercises as well

e) Of course, this has to be moderated, based on to the settings and environments where the computer and the operator are situated. For example, in an open office setting, such sounds may be disturbing to the people surrounding the operator. Some common sense considerations should be applied. For example, if desired, ear phones or the like could be used.

4. The Exercise Routines, their Selections and Variations:

a) The proposed exercises can be the same for every and all break sessions; or they can be varied. In other words, the exercises in all the break periods can be as those suggested in the first break period only, as in FIGS. 4 through 7; or

b) They can be varied and changed at every break period, as in the above example, where those exercises in FIGS. 10 and 11 were different from those in FIGS. 4 through 7. This would be determined and selected by the settings of the system's program, based on the suggestions of a team of expert advisors, and on the decisions of the administrator and/or the decision makers of the employer company or the like.

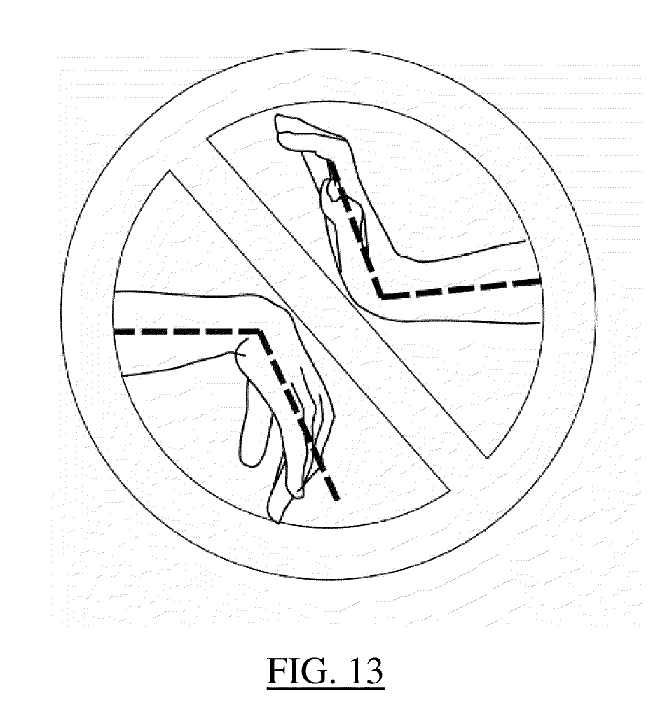

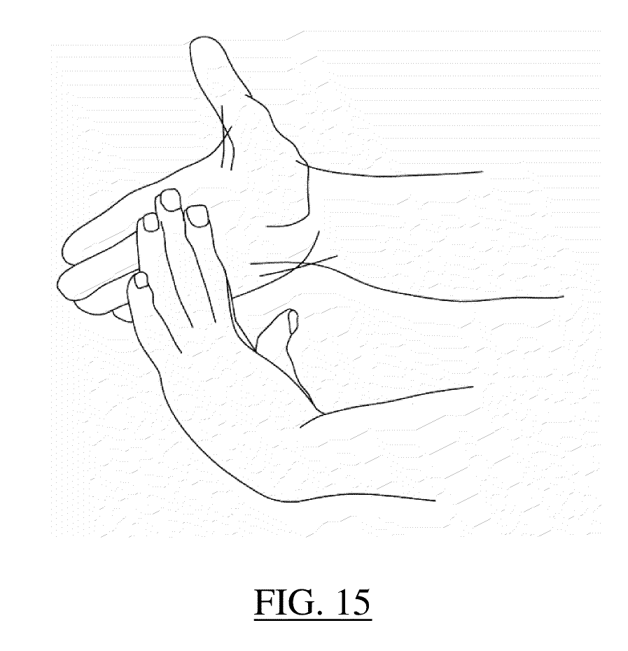

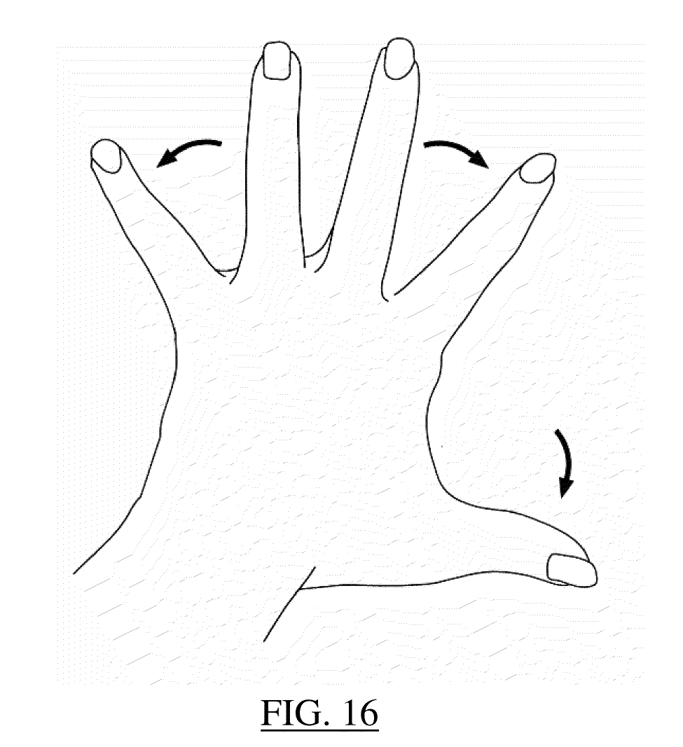

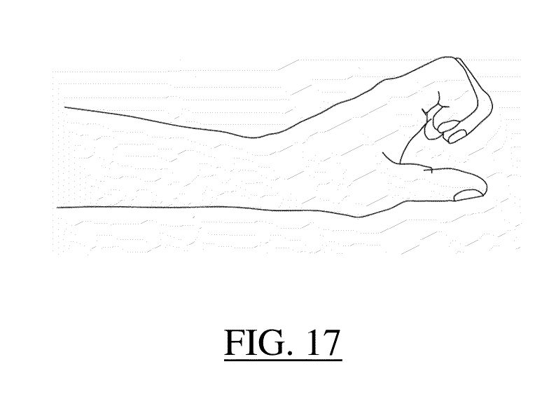

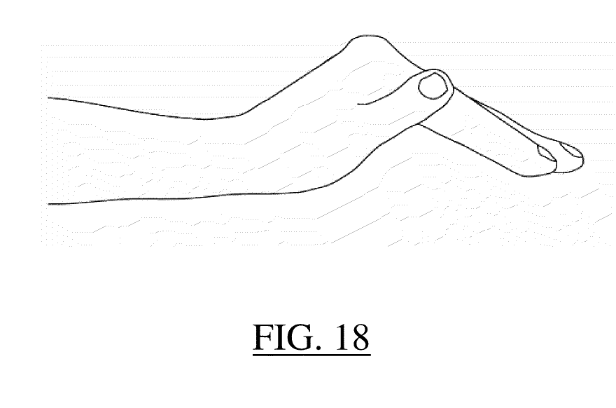

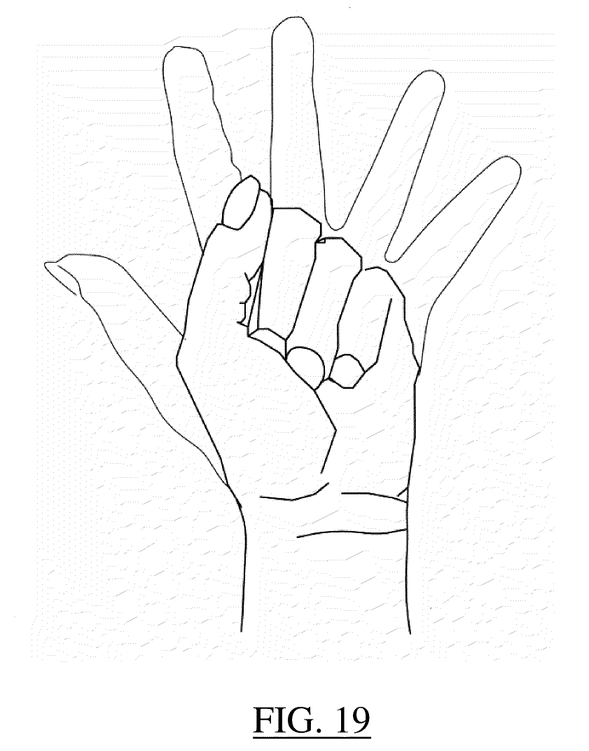

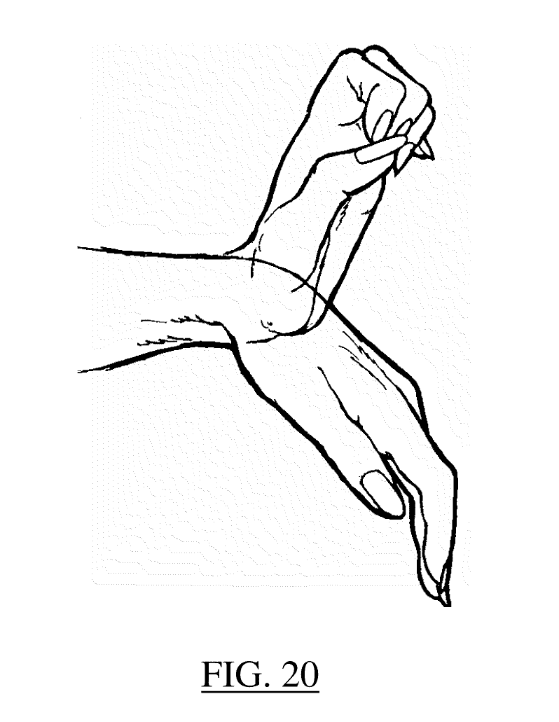

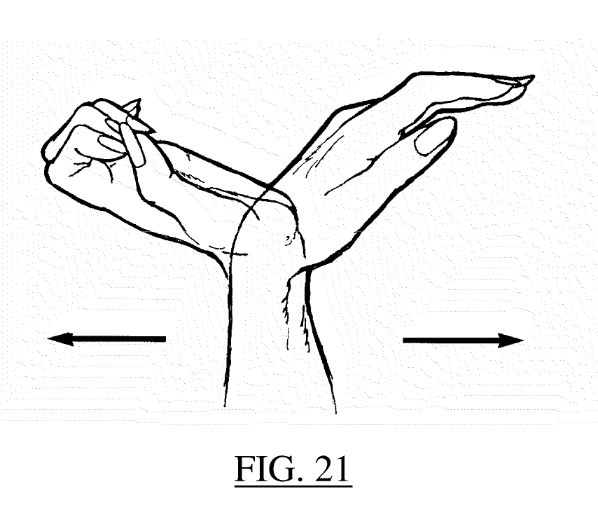

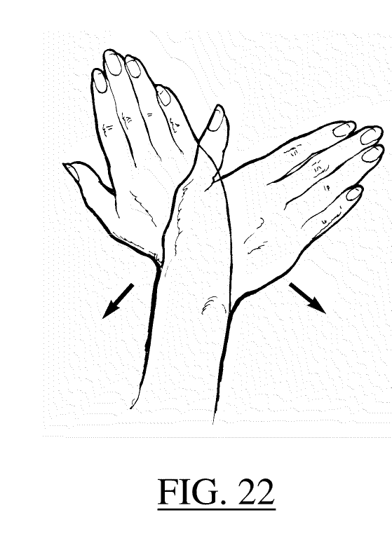

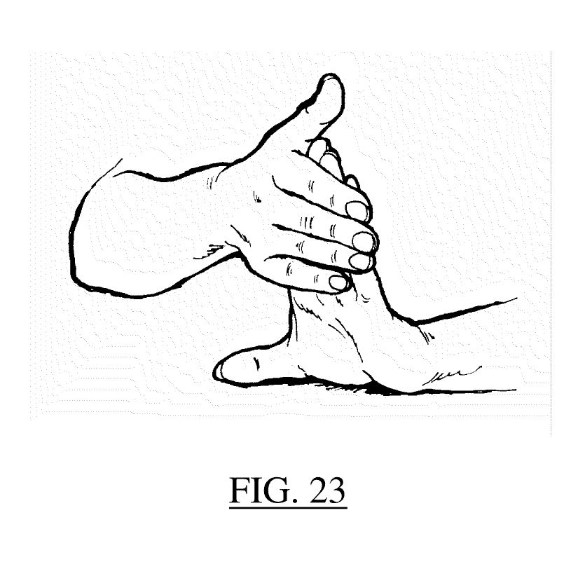

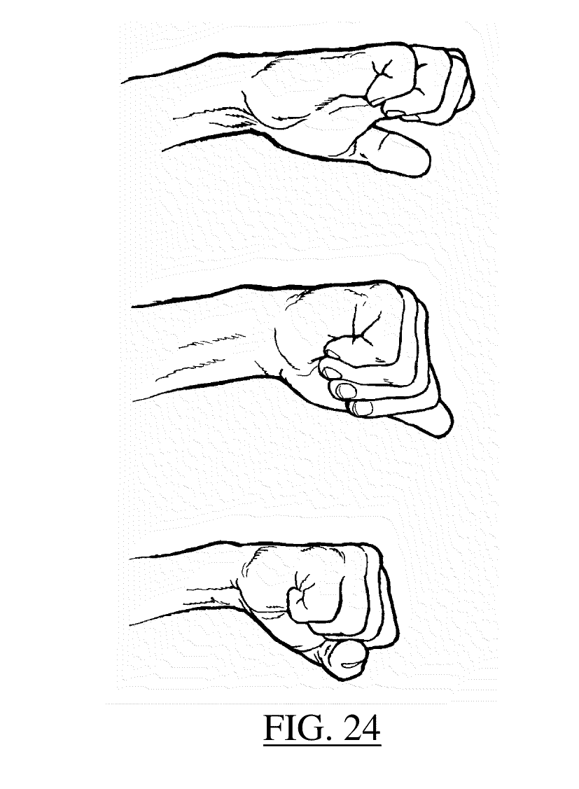

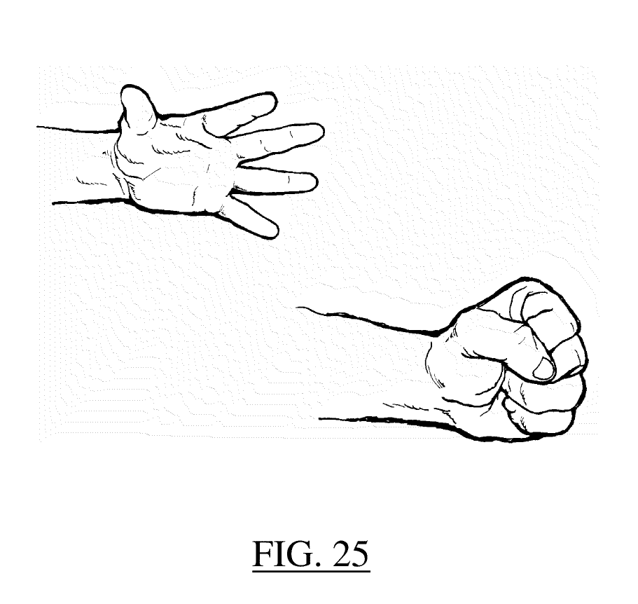

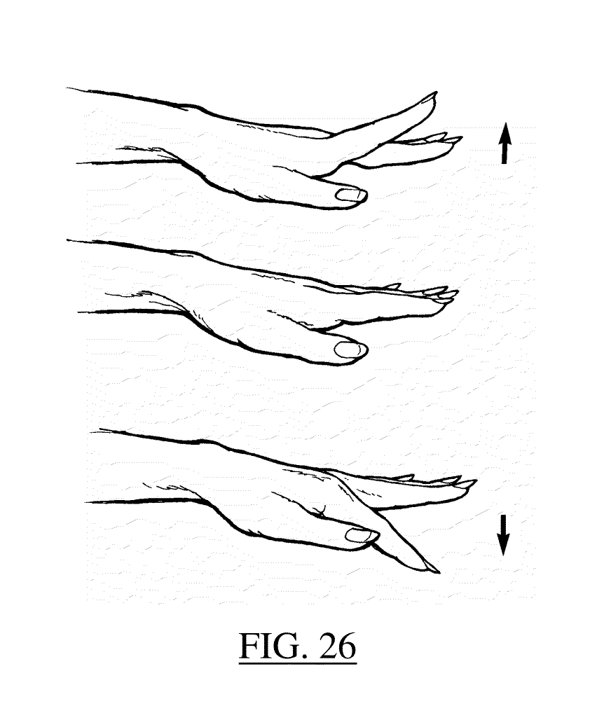

c) FIGS. 13 through 27 show samples of various instructions and exercises which can be provided by the system to the operator. The selection is almost endless. These figures/exercises are just to show the wide scope of instructions and exercises that can be included in the system and its programs.

i) FIG. 13 shows a warning, about what not to do.

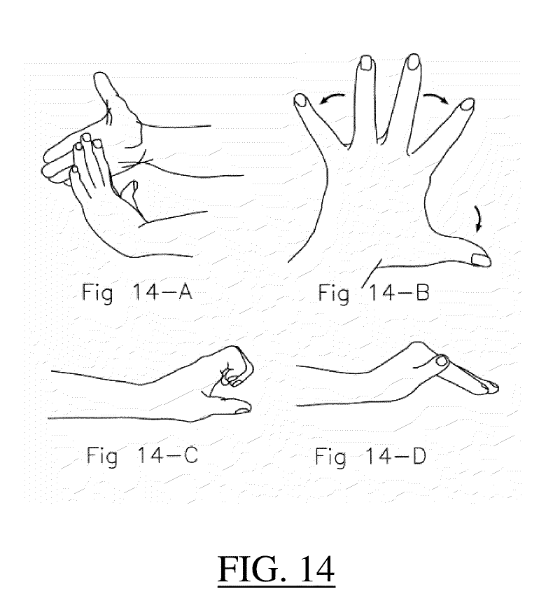

ii) FIGS. 14 through 26 show several exercises for the wrist, the hands and the fingers.

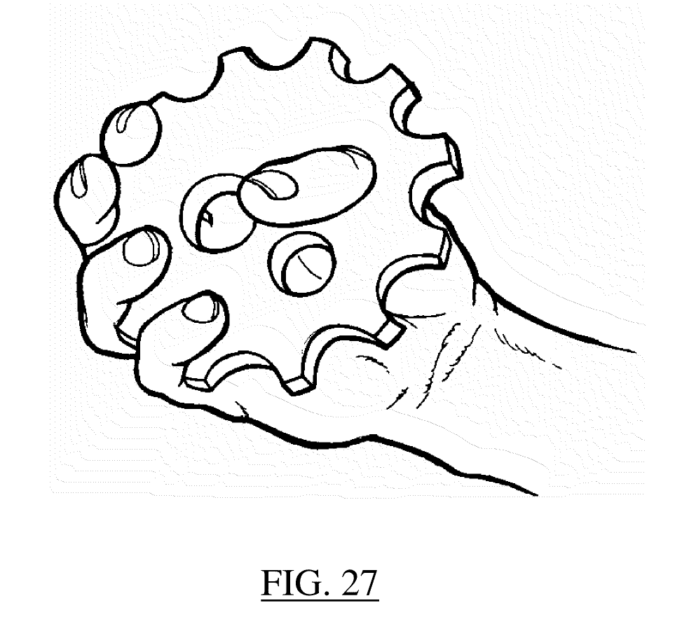

iii) FIG. 27 shows a “tool”, in this instant a “Finger Platter”, which can be used to help with some other additional exercises. Other tools could be included, like the compressible (stress) ball, or the spring loaded hand grip squeeze gadget, etc.

d) Also, the determinations of the length of time and the kind and number of exercises will vary depending on the nature of the work being performed or the activities being monitored, i.e. whether the operator is working on a computer or on a tractor or on a motorized jack hammer etc., or whether it is a patient in a hospital, lying in bed recovering from surgery, or whether it is a so-called “couch potato” watching television for many hours in a row.

e) Some other variations are conceivable.

f) The selection of the exercises will be determined by a cadre of technical, health experts and counselors, who would study all the factors involved and select the best appropriate combination of length and possibly the intensity, rate of speed or repetition, etc., of the Work Period and Break Period, and also the best appropriate exercises to suggest to the operator.

g) A lot of published articles and studies on the subject are available on the Internet and the technical and medical field. Our counselors can utilize this information, to formulate the exercises on this system, and/or they can supplement and add any other exercises or routines, based on their own research findings. In case we utilize third party material, we will work out appropriate licensing agreements with the originators of such material.

h) The exercises selections and recommendations will be updated periodically as we learn more about the pros and cons of the whole system.

5. Selecting the Measurements Taken During the “Work Period” and Determining their Effects and Importance, and Deciding on the Length of the Work Period and the Break Period:

The system can count or measure various things or factors during the “active”/“work” period in at least one of the following ways:

a) Measure just the actual time elapsed from the moment the computer is turned on, and terminate the Work Period when the allowed length of time is reached, regardless of whether the operator resumes the work at all or not, or

b) Measure the time starting at the first moment the operator hits any key on the keyboard, or clicks and uses the mouse, until the Allowed Work Time is reached, regardless of how often the operator hits any other keys on the keyboard or how often he uses the mouse, or

c) The time measurement starts at the first moment the operator hits any key on the keyboard, or clicks and uses the mouse, as in the above option, but the value of the time count gets moderated or modified by how frequently the operator hits the keys and/or how fast he does so. In other words, take into consideration the number of clicks per min, Total number of clicks and then factor in the total # of clicks/Hr together with the total length of time. For example, the length of the work period could be shortened if the operator is a fast typist, and conversely, it could be stretched longer if the operator is a slow typist, in other words, the length of the work period will depend more on, and could be moderated by, the actual number of keystrokes made by the operator.

d) It can also be moderated by whether the operator works in “bursts”, i.e. works furiously for a few minutes, and then rests idle for another few minutes and so on,

e) Also, the determinations of time and exercises will vary also depending on the nature of the work being performed, i.e. whether the operator is working on a computer or on a tractor or on a motorized jack hammer etc.

f) Other settings options include the length of time of the “work period” and the length of time of the “break period”. They can be set so that the work period would be say 55 minutes and the rest period to be 5 minutes, or they can be 148 minutes and 2 minutes respectively, or any other combination. Ideally, the length of times should be set based on some scientific and/or medical studies, which would be tested and verified before making them as a rigid law or cast in concrete. They would also vary, most probably, depending on the physical conditions of the operator, and many other factors. The experts can decide.

g) Another way is to make the work period longer at the beginning of the work day, and then successively shorter as the day goes by, or maybe make the break periods longer as the day wears out.

h) The settings can be manipulated by the “administrator”, or the operator may be authorized to change those settings at his pleasure.

6. Overriding the System and Consequences:

a) The system can either allow the operator to follow the system's instructions or to over-ride them, i.e. the operator would decide whether to take the suggested break period or to continue to work according to his/her wishes and desires; or

b) On the other hand, the system can force the operator to stop working, say by “locking” the computer and preventing the operator from continuing to work any further until the break period has lapsed.

c) the system could block all and/or any other programs that are running at the moment the break period starts, and places the RSS program windows “on top” of everything else; or just sit side by side together with the other programs.

7. Statistical Data Collection and Consequences of Overriding the System:

a) The system can have a “history log file” capability, which would record the behaviour of the operator, to have a history of whether the operator has over-ridden the system and did not follow the instructions of the system. We will refer to this function as the “statistical data collection”.

b) The “history log file” can be saved within the computer itself, or can be saved and/or duplicated at a central location, like at the IT centre of the employer company of the operator.

c) This statistical data collection will have to be made public knowledge, so that the operator would be aware that this is happening. This can be done, so that the operator would be encouraged to follow the system's instructions, to minimize the risks of operator contracting the undesirable carpal tunnel syndrome. Besides being the decent thing to do, this should be made public and known to the operator, in order to comply with any and all labour and any other applicable laws and/or ethics.

d) It is important to explain to the users that this statistical data collection information would be collected, first for statistical purposes to determine the efficacy of the system and program, and once the system is proven effective, then to help reduce the insurance cost burden on the employers. In other words, we will first try the program and the system as “advisory” and then after research proves it effectiveness, then we could make it mandatory and legal defence in insurance cases.

e) It may be safe to over-ride the system occasionally, but consistently ignoring the system's suggestions may be detrimental to the health of the operator.

8. Availability and Marketability

The CTS PEP program could be installed in/on every new computer being sold on the market, similar to other programs like Windows Office, the prior art Screen Savers, and/or Norton Symantec. This can be on a permanent basis, like the MS Operating System, or the Windows Explorer, etc. Or it can be on a Trial Basis, like the Norton Symantec, which gives the new computer owner the chance to use the program for a certain length of time, say 30 or 60 days, after which the user either buys the program or the program would stop working.

The program can be made available for different operating systems, e.g. for Windows as well as for MACs or for both.

9. When does the Program Start.

The program could be set up so that it will start automatically, whenever the computer is started or rebooted. This would happen without the operator's intervention, similar to most Screen Savers programs. Again the operator may opt to turn it off, again like most Screen Savers.

10. Announcement Re Updates and Newsletters on a Special Website.

The Major “Standard” System Components and Functions or Capabilities of the Pep CTS Reverse Screen Saver (RSS) Embodiment:

In this PEP CTS Reverse Screen Saver (RSS) embodiment, we notice certain main components in the system. I look at them as the “standard” components of any “PEP” embodiment, whether it is this PEP CTS RSS or any of the other embodiments described later on below. They include at least some or all of the following elements or components:
1. An input or sensing device or component, e.g. the keyboard and/or the mouse. Later on we will see embodiments that use other input components, such as pressure sensors, temperature sensors, humidity sensors, water level sensors, or pedometers, speedometers, etc.
2. A monitoring device or component, which in this case is built in the system's program, and which is similar to the monitoring system of the conventional prior art screen savers, and which monitors the activities of the operator. Later on we will see embodiments that use other monitoring components, such as pedometers, speedometers, etc.
3. An output component, e.g. the computer monitor screen, which tells/alerts the operator what to do, e.g. encourages the operator as to when to take a break and when to resume the work. Later on we will see embodiments that use other output components, such as a PDA/Palmtop, a Pager, a Cell Phone, or a simple Ear Plug/Phone, or a Speedometer, a Pedometer, or a simple Beeper, etc.
4. An instructions component, which suggests to the operator certain sets of activities during the break period. In this case, the system was suggesting doing certain exercises, but it can suggest to stand up and to take a walk, or to drink some water or whatever other activities that the system would deem appropriate.
5. A feedback component, which tells the system whether the operator has followed the given suggestions, or has overridden the system or turned it off altogether. The system can record whether the operator has kept on working or has at least had an “idle” time. Another possibility would be to have a video camera built in the computer, which many laptops and computers have already, and then the camera would record that the employee did do the exercises. This last thing may be too drastic of a step and may be objected to, as “intruding on the privacy of the employee”, and I would object to it myself. I do not recommend it, but technically it is doable, albeit, not very desirable.
6. A logging component, which records the historical events, and finally
7. A “brain” component of the system, which will control all the other components and their functions and operations. Usually this is the CPU, which is built in the computer, or it is the one built in the server at the IT centre. In other embodiments described later below, the “brain” could be an embedded chip of some sort built in the Smart or PEP device, and which would be programmed by an embedded software, which is sometimes referred to as the firmware. See the next paragraph re the software program.
8. A “software” program, which is referred to as firmware in other embodiments. This program will be installed in, or loaded, in the “brain” of the system, and will tell the brain what to do. It will receive the input data, process them, compares them against the “standards/limits/settings” stored in the program, and then decides on what needs to happen and accordingly would issue instruction as to what course of action is required at different instances of time.
9. Some interconnections means to connect all the above components and elements together, so that they can communicate the necessary data/information among each other and so that they can accomplish their intended purposes. In this embodiment, the interconnection means are all mostly within the computer itself and include the wiring or cabling that exists between the computer and the IT centre, if that is the case. In this and other embodiments, we could use wired connections or even wireless components, e.g. Bluetooth or Wi-Fi or the like, to give the operator more freedom of movement.

A simplified Flow Chart of the RSS Program

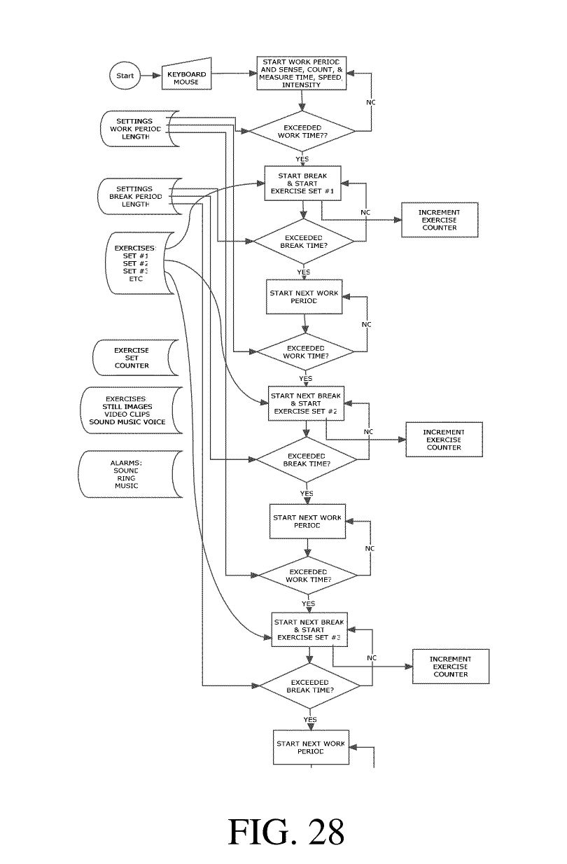

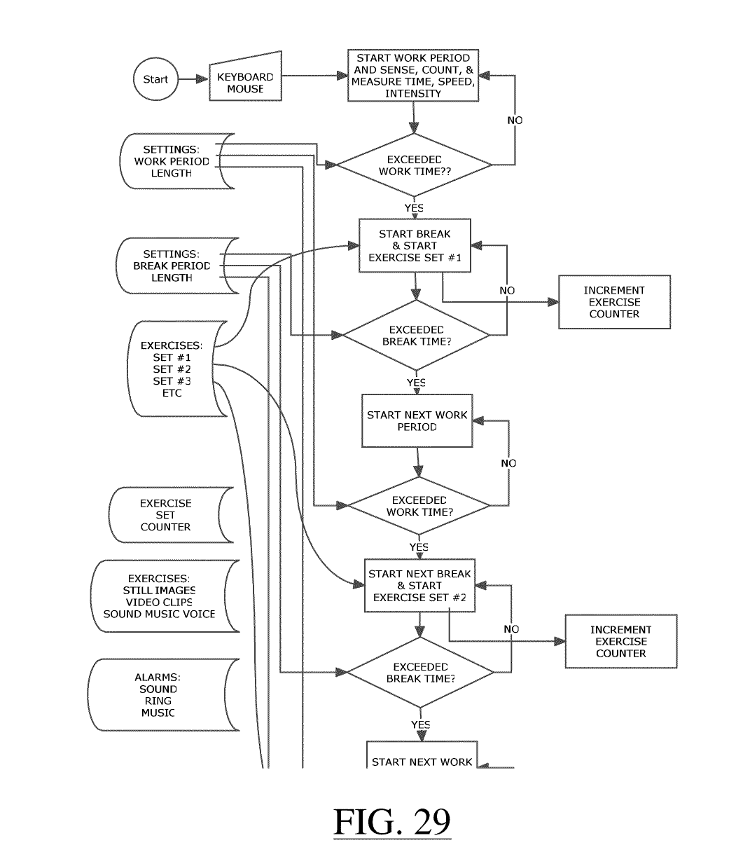

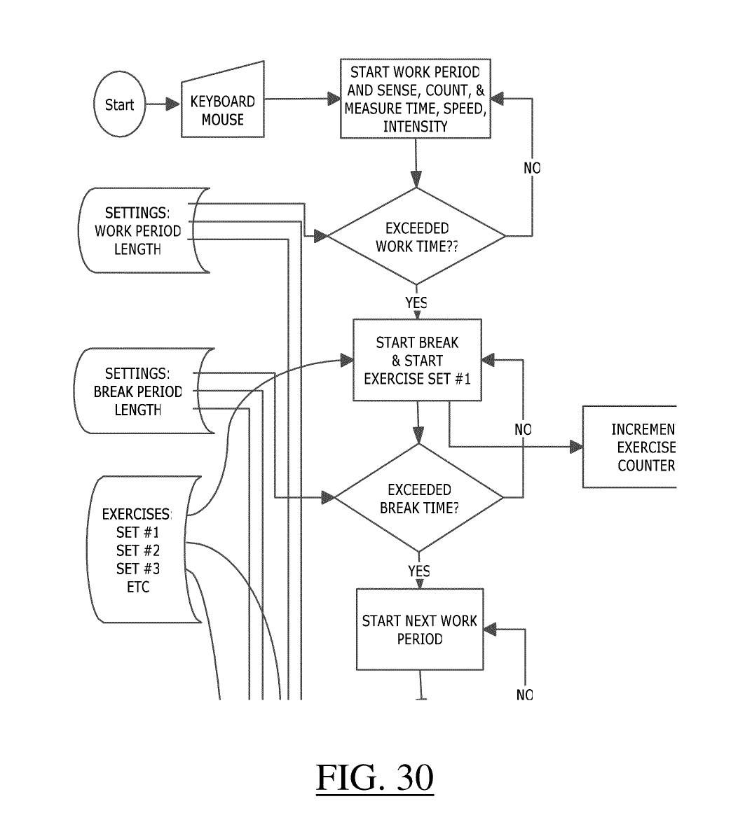

FIGS. 28 through 30 show a simplified flow chart, which illustrates an example of the functions and process steps of the software (or firmware) of the Reverse Screen Saver Program. FIG. 28 shows the typical major steps, while FIG. 29 zooms in and shows in more details only the top half of the flow chart in FIG. 28, and FIG. 30 zooms in further yet. They all show the same details shown in FIG. 28.

FIG. 28 shows, at the left hand side, the “Start” button, and under it many of the “settings” that can be preset at the beginning of running the software program or during the “installation” process of the program. Of course, most of these settings can be changed afterwards, whenever desired or necessary. All the way at the top, we have the “Start” button, to initiate and start the program. Once started, the program will monitor the activities of the operator on the keyboard and the mouse, which are the main input devices for any regular computer. If the computer uses for example a “touch screen” for some or all of the inputs, or eye movement monitor, these too could be used as the “input” devices. The software will direct the computer and its elements, to monitor the activities of the operator, how long has the operator been working at the computer and to count the number of clicks on the keyboard and/or the mouse and from these primary input readings, the program would then determine or calculate the time, speed, intensity etc of the operator and his activities, and decide on the next steps of the program.

So, we can see in the second row that the program goes through a decision operation or sequence. Did the work session reach or exceed the allowed time for the “work period”? For that determination, the program compares the actual elapsed time against the allowed time which was entered in the “settings” for the work period, as shown to the left of this decision block. If the actual time has not yet reached or exceeded the allowed time settings, then the program will continue to monitor and will let the operator continue to work on the computer. But once the program determines that the work period has reached or exceeded the allowed time, then the program initiates the next step of the program, i.e. it starts the “break period” process, as shown in the block below this decision block.

Under this block, we see the second decision block. The program keeps track of the break time and compares it with the allowed break period length. Again, the program goes through a similar measure, compare and decide operation. The program compares the actual elapsed time of the break against the allowed time for the break, which is in the settings block to the left, for the allowed break time. If the actual break time did not reach or exceed the allowed break time, then the program allows the break period to continue. If the actual break time does reach or exceed the allowed break time, then the program stops the break time and starts a new work period.

After that, the cycle repeats itself again and again, until something terminates the whole program, as explained later.

During the break period, the program, depending on the prior settings, can do any one of the following:
a) Nothing. The program can just maintain the screen that says that it is “Break Time” until the break period time lapses and then it would switch to the “Work Period”, or
b) The program can go to the “Exercises Sets” as shown in the storage block to the left, and pick one set of exercises and show them on the screen, encouraging the operator to follow the suggested exercise. This can go on until the break period lapses at which time the program would start the following work period,

Now, there are a few more options that could be available or could occur during the break period.

The exercises can be selected from various sets of exercises, which can be stored previously and stored in the storage space indicated by that block to the left. There could be exercises geared to the upper extremities, e.g. the hands, the fingers, the wrists, the elbows, the shoulders and the like. There could also be other sets of exercises geared for the back, the spine, the hips, the legs, the ankles, the toes, etc. There could be instructions regarding the “posture”, e.g. “don't slouch”, sit up right, etc.

So, the program can be pre-programmed to do any one of the following:
a) Select one set of exercises and use that one particular set all the time, i.e. at every break period, without changing anything in it, or for a whole day, or for the whole life of the program, or
b) Select the first set of exercises for the first day of the week, the second set for the second day, the third set for the third day, etc., or
c) Select the first set of exercises for the first break period, and then the second set of exercises for the second period, the third set for the third period, etc., or
d) Select any set of exercises, at random, for the first period, another set again at random for the second period, etc.
e) Or just “scramble” the exercise sets, like some songs or music CD players.
   After we use the program for some time and determine which of the above alternatives makes more sense, we may opt to limit the selection variations to what seems more beneficial.

Another group of choices for the break periods includes:
a) The exercises could show only “still images” of the suggested movements, or
b) They could be shown using “video clips” (Streaming video with or without streaming audio), showing a person physically going through and demonstrating the movements, or
c) There could be some “narrations”, explaining the exercises, highlighting the important “fine points” which would make the exercises more effective, or
d) There could also be either some music or various sound effects or voice over visuals, to help and to encourage etc.

All the above options and variations, would be entered into the program as “settings”, to be selected either during the installation of the exercises software, or at any subsequent time.

Back to the flow diagram in FIGS. 28 through 30.

On the right hand side, we see the block that reads “Increment Exercise Counter”. This is a trick used in programming to change the selection of the exercises from one operation to the subsequent operation or choice. For example, when we start the first break period and start to use and show the exercise set #1, the program changes the setting on an “Exercise Counter”, from its original setting to the subsequent count. For example, if the exercise counter was set to the number “1”, then during this first break period, the program would increment the number on the counter by a “preset increment”. If this preset increment is “1”, then during this first break period, the exercise counter would be changed from its original reading of “1” to the new reading of “2”. So, when the next break period, i.e. break period #2, starts, then the program would select the Exercise set #2. And it will increment the exercise counter to “3”. Then during the subsequent break period, i.e. break period #3, the program will accordingly select the exercise set #3. And so on.

If the “preset increment” was set to “3” for example, then the program would select exercise set #1, then #4, then #7 and so on.

The preset increment itself can be “incremented” as well. For example, it can start with the number 1, and the following day it could be reset to the number 2, etc.

The purpose of all these gymnastics or manipulations is to create some variety and unpredictability in the exercise routines, so that they would not become too monotonous and become “too old” or too predictable.

Another way to do it is to have a smaller set of exercises that would be done every break period, calling them the “staples”, and another small set of exercises that change every day or even every period, as described above.

Again, all this would be studied and evaluated and the decisions and selections will be refined as we learn more how to make the system more efficient and beneficial.

Possible Versions of the PEP1 CTS Program

The program could be offered on the Market in any one or all of the following versions. The following two tables show the possible features of the possible different versions:

Possible Versions of the PEP1 CTS Software Programs

Page 1 of 2

| | | Version | | | | |
|---|---|---|---|---|---|---|
| Features | # | Enterprise | Professional | Business | Office | Home |
| Monitors Straight Time Computer | 1 | YES | YES | YES | YES | YES |
| Running | | | | | | |
| Monitors Number of Strokes on | 2 | YES | YES | YES | YES | YES |
| Keyboard | | | | | | |
| Monitors Number of Clicks on | 3 | YES | YES | YES | YES | YES |
| Mouse | | | | | | |
| Monitors Force Intensity on Keyboard | 4 | YES | YES | YES | YES | |
| Factors-in Strokes into Time | 5 | YES | YES | YES | YES | |
| Measurement | | | | | | |
| Factors-in Clicks into Time | 6 | YES | YES | YES | | |
| Measurement | | | | | | |
| Factors-in Intensity into Time | 7 | YES | YES | YES | | |
| Measurement | | | | | | |
| Factors-in Breaks into Time | 8 | YES | YES | YES | | |
| Measurement | | | | | | |
| Factors-in ALL the Above into Time | 9 | YES | YES | | | |
| Measurement | | | | | | |
| Issues Alarm Beeps, with override | 10 | YES | YES | YES | YES | YES |
| Issues Alarm Voice, with override | 11 | YES | YES | YES | | |
| Issues Alarm Music, with override | 12 | YES | YES | | | |
| Issues Suggested Exercises- Still | 13 | YES | YES | YES | YES | YES |
| Drawings | | | | | | |
| Issues Suggested Exercises- Still | 14 | YES | YES | YES | YES | YES |
| Pictures | | | | | | |
| Issues Suggested Exercises- Video | 15 | YES | YES | YES | YES | |
| Clips | | | | | | |
| Issues Suggested Exercises- | 16 | YES | YES | YES | | |
| Combination | | | | | | |
| Provides Text Instructions w | 17 | YES | YES | YES | YES | YES |
| Exercises | | | | | | |
| Provides Voice Instructions w | 18 | YES | YES | YES | YES | |
| Exercises | | | | | | |
| Provides Music w Exercises | 19 | YES | YES | YES | | |
| Provides Cadence w Exercises | 20 | YES | YES | | | |

Possible Versions of the PEP1 CTS Software Programs

Page 2 of 2

| | | Version | | | | |
|---|---|---|---|---|---|---|
| Features | # | Enterprise | Professional | Business | Office | Home |
| Allows Setting Length of Work | 21 | YES | YES | YES | YES | YES |
| Period Time | | | | | | |
| Allows Setting Length of Break | 22 | YES | YES | YES | YES | YES |
| Period Time | | | | | | |
| Allows Incrementing Length of Work | 23 | YES | YES | YES | | |
| Period Time | | | | | | |
| Allows Incrementing Length of | 24 | YES | YES | YES | | |
| Break Period Time | | | | | | |
| Provides Weekly Scheduling of | 25 | YES | YES | | | |
| Work & Break Period Times | | | | | | |
| Has only one set of suggested | 26 | YES | YES | YES | YES | YES |
| exercises | | | | | | |
| Has exercises for upper and lower | 27 | YES | YES | YES | YES | YES |
| extremities | | | | | | |
| Has several sets of exercises | 28 | YES | YES | YES | YES | |
| Has suggestions for Posture | 29 | YES | YES | YES | | |
| Has suggestions for other helpful | 30 | YES | YES | | | |
| tools | | | | | | |
| Allows for selecting the exercise | 31 | YES | YES | YES | YES | YES |
| sets | | | | | | |
| Allows for “Cycling” the exercise | 32 | YES | YES | YES | YES | |
| sets | | | | | | |
| Allows for “Scheduling” the exercise | 33 | YES | YES | YES | - | |
| sets | | | | | | |
| Allows for “Adding” other exercises | 34 | YES | YES | | | |
| IT Centre Network Capabilities | 35 | YES | | | | |

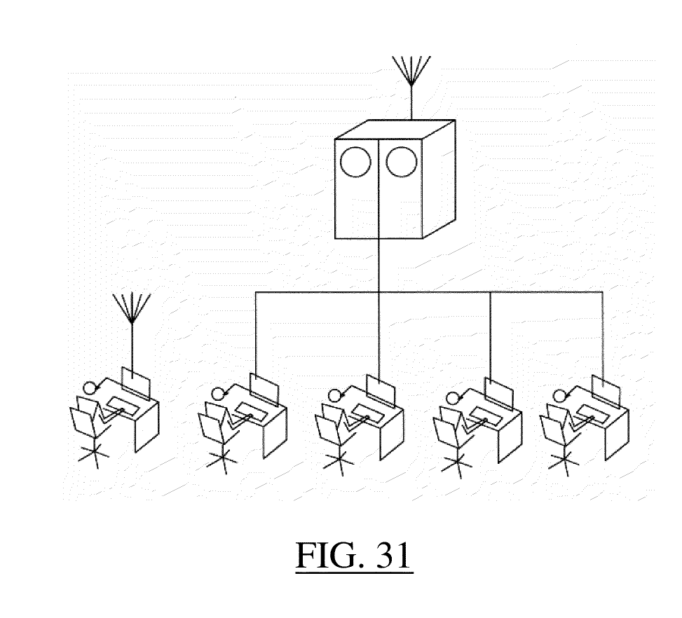

Other General Notes re Embodiment #1:
1. Advice while hand is healing. E.g. after surgery or being hurt slightly. As it heals, what to do and what not to do.
2. FIG. 31 of Network
3. Wired or wireless; Ethernet or cable too, as well as wireless.
4. Have different versions that can be used on MACs or PCs or BOTH.
5. List the sources of websites, books, articles etc. of the info, especially the pictures/Figs.; Medical Board, medical doctors therapists, etc.; examples of exercises for the “legs”, “back”, “neck” and the like; sort thru the book and collect what is applicable.
6. Medical Board>>Committees by Products; concentrate first on one and then afterwards on others and spread out.
7. We may not use a screen saver; we may just use a “start” button to initiate our “CTS program”. This Start button would be on the computer desk top, and it could be inserted there when our CTS program gets installed in the computer. Of course, the user can also start the program, by going to the “Program Files” in the C-Drive, then by finding the CTS program folder, then sorting by “type”, and looking at the Application files, with the .exe extension, then the user will find the executable file for our CTS program. The user can either click on that file to open and to start the program, or the user can create a shortcut file for that executable file, and would cut the shortcut file/icon and past it on the desk top. This way, it would be easier for the user to start our CTS program directly from the desk top, instead of going the long way around.
8. Once the patent application is approved and a patent is issued and we will be preparing to start marketing the inventions herein, then we will make sure to get the appropriate licenses from any author of any picture or exercise that we want to incorporate in our products.

### Other Embodiments

Several variations of the above RSS embodiment can be visualized and implemented, based on the general basic principles described above. Some examples include the following ones.

Embodiment #2: A road construction operator works for hours on end, operating a motorized jack hammer. Solution: the Smart or PEP Glove.

Embodiment #3: An athlete gets on the treadmill trying to improve his/her endurance, and may overdo it and could hurt him/herself. Solution: the Smart or PEP chest or wrist heart rate strap/monitor, together with the PEP wrist watch, or PEP pager, or even the PEP cell phone.

Embodiment #4: A hiker keeps on walking for hours on end and gets dehydrated. Solution: the Smart or PEP Pedometer, the Smart or PEP Water Bottle, the Smart or PEP Wrist Watch, the Smart or PEP Cell Phone.

Embodiment #5: A biker keeps on pedaling for hours on end and also gets dehydrated. Solution: the Smart or PEP Speedometer, the Smart or PEP Bike Seat, the Smart or PEP Handle Bar, the Smart or PEP Pedals, and again the Smart or PEP Water Bottle, the Smart or PEP Wrist Watch, the Smart or PEP Cell Phone.

Embodiment #6: Office Chair/Seat

Embodiment #7: A sedentary person watches television for hours on end, and many of his joints “gets stiff” and suffers from arthritis and the like. Solution: the Smart or PEP Easy Chair or the Smart or PEP Sofa.

Embodiment #8: A patient in a hospital lies in bed for hours or days on end without moving and gets bed sores or his/her arthritis hurts him/her more. Solution: the Smart or PEP Bed.

Etc.

They can be grouped in two groups.

a) ACTIVE: One group covers “action” activities, like keyboarding as described earlier, and walking, biking and the like.

b) IDLE: The other group covers the opposite king of activities, i.e. “inaction” or “idle” or “sedentary” activities, like sitting, lying down, and the like. These embodiments of the present invention address the ill effects of such sedentary activities, like remaining idle and in one position and/or doing nothing, for long periods of time. Examples of such situations are: a) driving a car or truck long distances, without stopping and without getting out of the car and stretching or even without re-adjusting your seating position; b) sitting too long in one position in front of the computer or watching television, etc. The ill effects of doing that is that you “become stiff”, as the term goes; c) lying in bed for long periods of time, say after a surgery, and getting bed sores.

Embodiment #2. Active. The Smart or PEP Glove

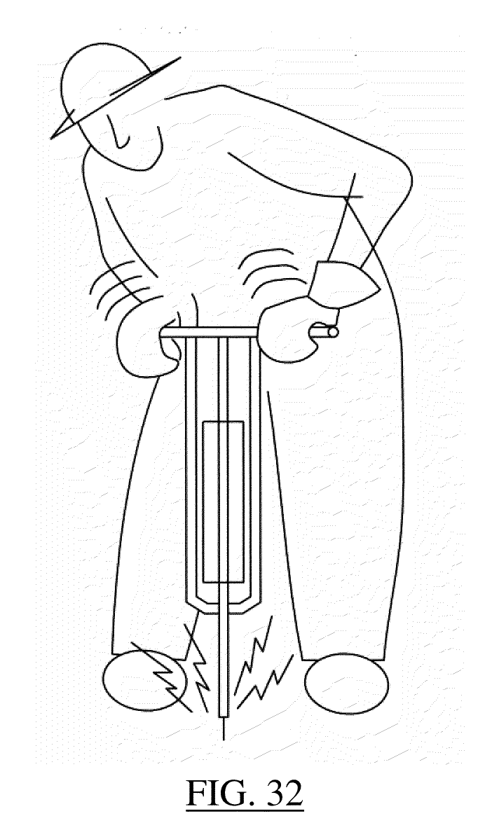

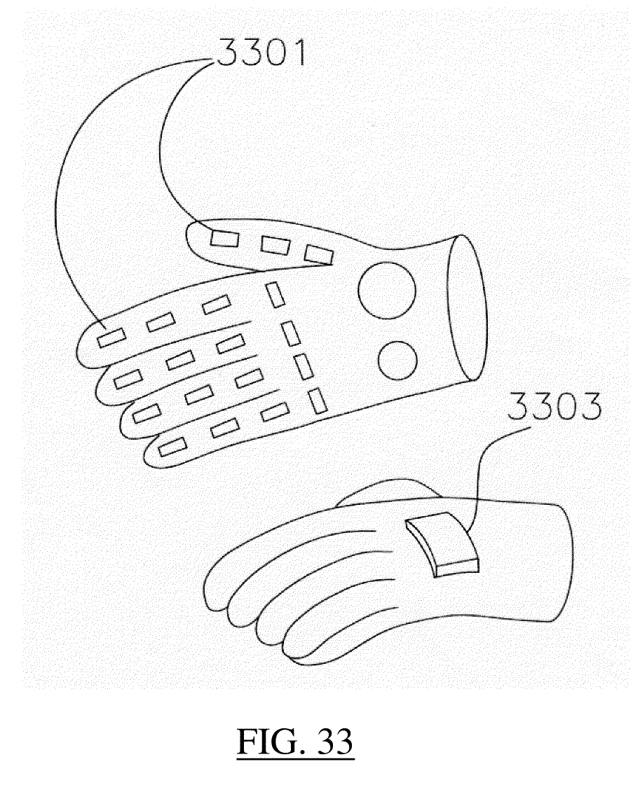

See FIGS. 32 and 33. A second embodiment of the invention is shown in FIG. 33 and it is what I refer to as the “Smart or PEP Glove”. In this embodiment, the input component of the system would be in the shape of a regular glove, like those used for the respective intended trade. The Smart or PEP Glove would have appropriate sensors 3301 located at certain appropriate points, inside and/or outside the Smart or PEP Glove structure, and adapted to the specific task that needs to be monitored.

The Smart or PEP Glove can be used to help people who use their hands in a way that could lead to unfavourable results. For example, an operator of a motorized jack hammer, as in FIG. 32, can hurt his wrists, his elbows, his shoulders, his back, etc., if he/she keeps working for long periods of time without taking some breaks and/or without taking certain other precautions. So, in such a case, the system would monitor the activities of such a person and alerts him/her to take the appropriate breaks and to do whatever is the right thing to do for such a person, to minimize the risks of getting the undesirable bad health results.

A road construction operator working for hours on end, operating such a jackhammer, would love to have such a Smart or PEP Glove, or at least would benefit from using it.

Trades or activities utilizing Air Tools could be exposed to the same stresses and to similar potential hazards as the motorized jack hammer.

Wikipedia and/or Google list a large group of tools, which, in my opinion, can impart on to their users similar harmful effects as the “jackhammers”. The users of such tools could benefit from the smart or PEP glove. These include: Chipping Hammers, Clay Diggers, Concrete Chain Saws, Core Drills, Cut-Off Saws, Grinders, Machine Mounted Rig-Breakers, Paving Breakers, Post Drivers, Rivet Busters, Rock Drills, Saws, Tampers, and the like.

Again, refer to FIG. 33. A Smart or PEP Glove, as per the present invention, would have sensors 3301 that would monitor the work of such a person and would feed back that information to an embedded chip 3303, programmed to do the same thing as the CPU and the software of the Reverse Screen Saver would do for the computer operator.

In this case, the Smart or PEP Glove would send the signals and communicate with the rest of the system, either by wires or cables extending from the Smart or PEP Glove to the embedded chip or to an external computer and to the rest of the system, either by direct wiring or by wireless communications, e.g. by using Wi-Fi or something similar to the well known “Bluetooth” system used for short range wireless communications. The rest of the system could be: a) all enclosed within the PEP Glove, or b) carried on the operator's person, like a device similar to a cell phone or a personal pager, or like a portable computer, a Palm or an IPod or the like, which would interfaced with the glove and its sensors, either by direct wiring or by wireless. These portable devices then would provide the signals and instructions to the operator by one of several possible means, including an audible signal, possibly through an ear phone, or by a vibration signal, which could also be followed by or in combination with, audible or visual signals. Another way is to have the rest of the system located at a nearby location, so that the operator would be able to receive the commands from the system and would be able to respond to them.

The Smart or PEP Glove can be “self contained”. The “computing means” would be built-in the glove itself, as well as the “signalling means” too, which again can be sound and/or vibrations, where the vibrations can be directed to the back of the hand, to the wrist or the like. Most of the computing and controlling parts of the system can be contained inside an “embedded system chip”, with an “embedded program” inside that chip, so that the smart or PEP glove would be practically self sufficient without the need of an external computer to control it. The smart or PEP glove can of course communicate with other external computers, but basically just to “inform” them and to pass on to them certain data. See Embodiment #10 described later below.

The Smart or PEP Glove can be used in a number of other comparable applications as well. It can be used in any kind of jobs requiring manual manipulation of various objects, such as when a person is chopping firewood and stacking it in rows. We can also extend our thinking and use the Smart or PEP glove for various sports. For example, golf, baseball and the like. We can even extend our thinking further and use is when holding the steering wheel, when driving a car or truck for long travel distances.

The glove can also be used for general therapeutic purposes

Embodiment #3. Active. The PEP athlete's health/heart rate devices, including the PEP chest strap 3401, the PEP wrist watch 3403, the PEP pager-like instrument 3405, or the PEP cell phone (wireless hook-up and alerts).

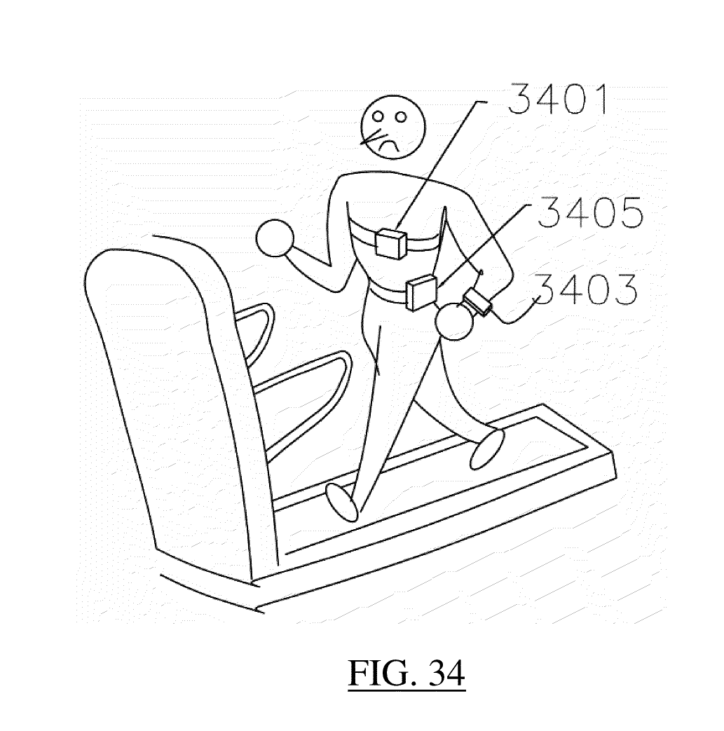

See FIG. 34. Many athletes, including cyclists and the like, use a “heart or pulse rate monitor” to “read” their pulse and sometimes other vital signs, to be aware of their physical conditions, while they are training or racing or competing. The signal coming out of those sensors are read by certain readouts, which simply tell the users about the specific conditions being monitored.

For example, an athlete would wear such a “sensing chest strap” 3401 about his/her chest and walks or runs on a treadmill as illustrated in FIG. 34. Some new treadmills have a monitor screen, which “reads” the pulse rate of the athlete and shows it on a monitoring screen. The signal coming out of the sensor at the chest of the athlete goes to the readout device, either by some sort of electric wire or cable or by wireless, e.g. by Bluetooth or Wi-Fi or the like.

Usually, the athlete reads his/her pulse and mentally decides for himself, whether he is overdoing it or not. Usually, the prior art readout instrument does not make any such decisions nor does it make recommendation.

Now, according to the present invention, our system would do more.

The system would be provided with the various necessary components of our system, as listed earlier, as per this invention, including a similar software program, which would observe for example the length of time any specific activity has been going on, and if and when, this length of time exceeds the “preset” length for the specific activity, then the program would issue a warning as described earlier in this specification. The signal can be an audible sound or even a “vibration” signal like those used with certain cell phones or personal pagers. And again, there are many variations and options that can be applied for this embodiment, similar to those listed with the PEP-CTS-RSS-etc embodiment. In other words, the PEP Heart Rate Monitor will monitor and watch the person's activity and, if it gets too much or excessive, then the system would start the CTS process and functions.

In addition, the sensor/monitor can take into consideration the “intensity” of the monitored activity, e.g. the level of effort exerted, to take that into account, and to incorporate those readings together with the “time” readings, in order to “adjust” the allowed time for any specific activity.

In addition, the system can be used with elderly people, to monitor other vital signs and health problems, in addition to monitoring just the heart rate. And it can be provided with an “emergency” feature that can contact and alert, by wireless or otherwise, certain care givers to a danger situation, say if the heart rate falls below a certain low rate, or stops totally.

A further extension of this embodiment is to make such a system, so that it would incorporate a sort of a defibrillator, which could be controlled and actuated either automatically or by remote control by a health provider or care giver, who would be sitting at a monitor desk observing the person carrying the system/device, which we can start calling as being an “instrument”. Then, if and when the situation warrants, the health provider could send a signal to the instrument, which in turn could give the patient a “jolt” to revive the heart and its heart beat, and to keep the patient alive until an emergency crew could arrive on the scene for further action.

This would be similar to, or maybe even better than, the system now available at certain hospitals, where they monitor patients' heart's vital signs. The patient is fitted with EKG electrodes that can sense and read the electric signals of the heart and body, and the sensors are connected to a controllable switch. When turned on, the sensors would send the readings to a central location, where a technician would be monitoring several such patients on a computer screen. If the shape of the patient's EKG chart looks abnormal, the technician alerts the nurses and the doctors, if necessary, to rush to the patient and administer any necessary medical treatment or procedure as need be.

In our case here, our system could be connected via wireless either directly to such a health care station and group of care givers, or via a telephone relay arrangement, so that in an emergency case, the system would alert the care givers to take the appropriate course of action.

In addition, our system could be instrumented so as to provide some of the therapeutic functions required to help the patient, e.g. give the patient an electric jolt to help his heart condition on, or the like.

This PEP athlete's health/heart rate devices can have many shapes.

As stated above, it can be as a “chest strap”, or it can be like a “wrist watch”, or it can be a “pager like instrument” or it can even be incorporated into the cell phone, in which case, I would refer to such a cell phone, as a PEP Cell Phone.

Some “joggers” prefer to use a gadget, e.g. an arm band or arm strap, that is strapped to their arm, usually between the elbow and shoulder, i.e. on the upper arm. That is fine, too. This could be like our PEP Pedometer, and it could read other vital signs as well, and then process all the collected info/data according to the present invention.

The PEP device could also be programmed to consider other factors in determining the length of time an athlete would exert him/herself before taking a break, or drinking water, etc. In this case, the athlete may be requested to fill in certain info in the system, like his age, weight, level of health condition. This is similar to some newer treadmills. Then when the athlete is working out, or jogging on the street, the PEP Strap for example, would beep to indicate to the athlete that: 1) he is approaching the limit, or 2) he has reached the limit, or 3) he has exceeded the limit. At each level, the beep could have a different tone, to indicate the urgency for action, or can beep at longer periodic rate at lower urgencies, and at a faster rate at a higher urgency, or could modulate the loudness of the signal in a similar fashion.

Embodiment #4. Active. The Smart or PEP Water Bottle and Ancillaries, including the Smart or PEP Pedometer 3501, the Smart or PEP Wrist Watch 3503, the Smart or PEP Cell Phone.

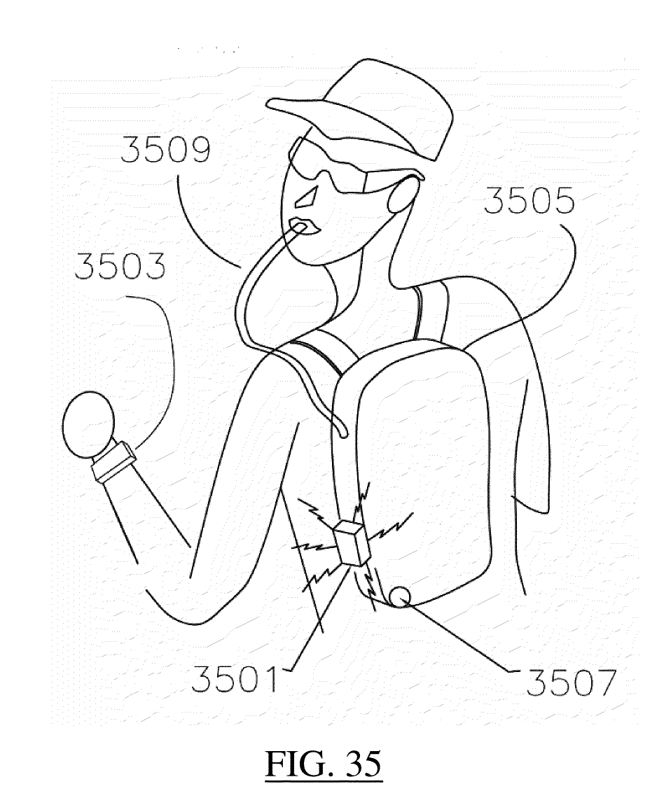

See FIG. 35.

A hiker keeps on walking for hours on end or a biker keeps on pedaling up and down a mountain, or a swimmer keeps on swimming laps and laps in a pool or lake, etc. Mountain climbers, too. Any one of them can easily get dehydrated, even the swimmer in the water. Many experienced athletes can determine whether they are reaching a dehydration situation, but some others don't. In either case, the following Smart or PEP Gadgets can be helpful: the Smart or PEP Water Bottle 3505, the Smart or PEP Pedometer 3501, the Smart or PEP Wrist Watch 3503, the Smart or PEP Cell Phone.

Notice also the Water Level Sensor 3507.

Most of us have seen or heard about the “pedometer”. It is basically a counter that senses the motion of a person walking and counts the number of steps that the person has taken. It shows the count in a small window in the housing of the pedometer. With a simple push of a button, you can reset the counter to Zero and start all over again. Some pedometers have a few other features, but basically they all function practically the same way.

One embodiment of the present invention is the Smart or PEP Pedometer.

It would have a similar or equivalent sensing mechanism, which would count the number of steps, but in addition, it would have an embedded chip, programmed to do similar functions as the PEP-CTS-RSS— etc described above, with a few rearrangements to fit the application.

The embedded chip would track the total number of step, as well as to elapsed time. Some advanced pedometer would be able to track also the temperature, humidity, altitude, and any other physical phenomena that could affect the health and wellbeing of a person or athlete. If and when the combination of all the sensed phenomena adds up to a critical point, then the embedded chip and the program would give proper notices and warnings to the person carrying the Smart or PEP pedometer. This can be similar to all the various notices and warnings mentioned above with the other embodiments. In certain more advanced embodiments, the system would be able to send, via wireless, e.g. the cell phone system or the like, appropriate messages to a remote receiver, to duplicate the information given to the person carrying the gadget.

Some of the alert/warning notices and/or messages could include: Take a rest, drink some water, do certain stretching exercises, etc. similar in a way to those of the PEP-CTS-RSS— etc.

Another embodiment of the present invention is the Smart or PEP Wrist Watch.

Sanyo or other companies have gadgets that look like a wrist watch, but they measure altitude, atmospheric pressure, etc, and some measure the heart pulse rate and the like. I am proposing to add certain features to such wrist watches, these features would be similar to those described above in the PEP-CTS-RSS— etc and the other gadgets.

The important ones of these new features would include: heart rate pulse, time duration of the specific physical activity done by the person carrying that wrist watch, and maybe his/her age, his/her body weight, general physical conditions, etc. And the wrist watch would produce similar alerts, warnings etc as described above with the other gadgets. These alerts, warnings, etc. could be given to the user only, or could be broadcast to some external third party monitoring persons or stations.

Another embodiment of the present invention is the Smart or PEP Cell Phone.

Cell phones are getting so popular. They are becoming almost inseparable, like a wrist watch. It is getting almost so natural for people to have a cell phone nowadays. In addition, cell phones are incorporating more and more features and capabilities built in them every day. So, why not add another capability to them, by incorporating in them, the same capabilities of the PEP-CTS-RSS—etc as described above for the RSS and the other gadgets.

Other General Notes re Embodiment #4:

1. Back Packs: by OSPREY; MOUNTAIN HARDWARE;

2. Pedometer Mfrrs: FITLINQ

Embodiment #5. Active. The Smart or PEP Bicycle

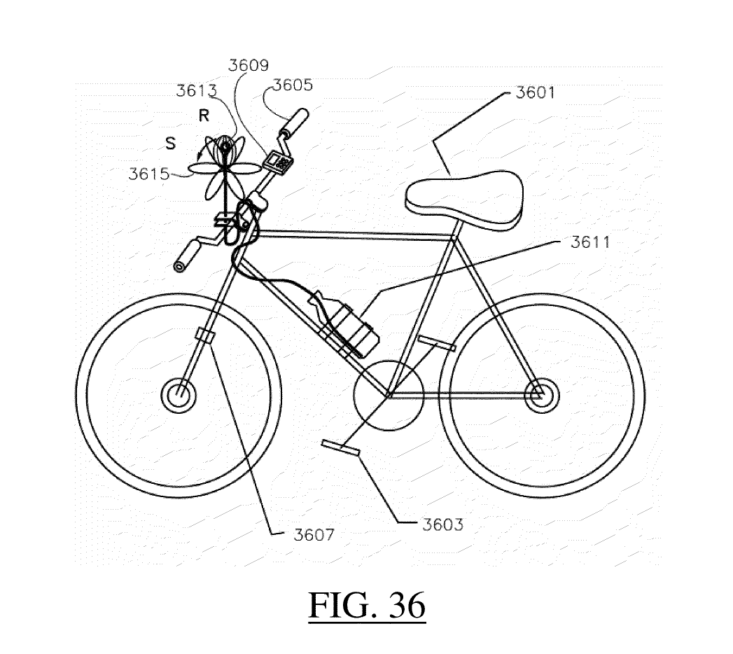

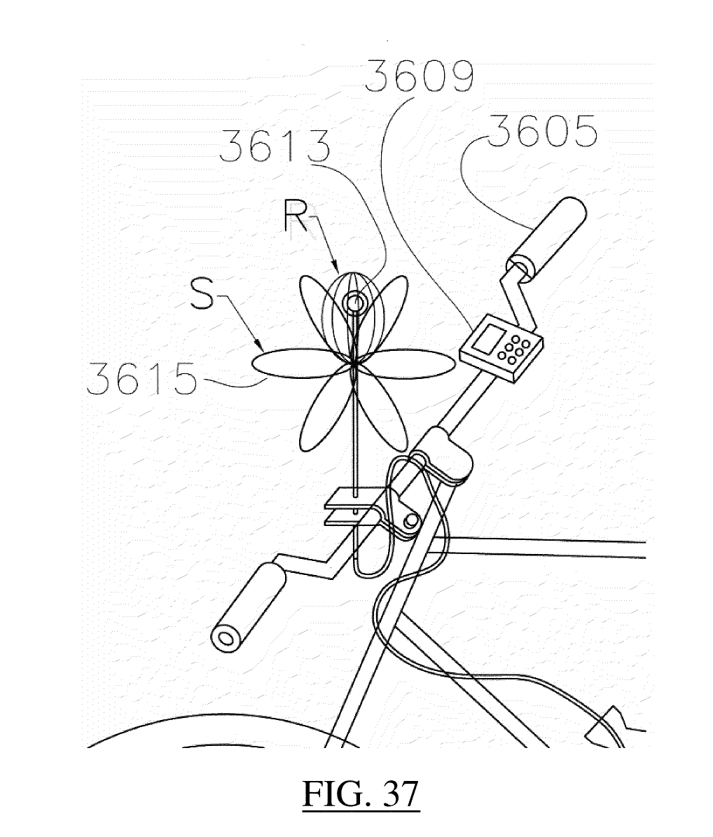

FIGS. 36 and 37 show some details of what I call the PEP Bicycle. We can provide “sensors” at different locations in the bike, so that we can monitor the biker's activities at several locations. We can easily visualize having sensors in the bike seat 3601, in the bike pedals 3603, in the bike grips 3605 of the handle bar and so on. These sensors would monitor and measure the pressures applied on them by the biker and would process the readings, in a similar way as described elsewhere in the present specification. Then these measurements would be compared against certain preset predetermined levels and limits. If and when these limits are reached or exceeded, then the system's software/firmware program would initiate similar alerts and/or warnings, again as described elsewhere in this specification.

Furthermore, a PEP Speedometer 3607 can be added. It would operate like most any prior art bike speedometer, but with the additional features of the PEP embodiments described in this specification. These features would include the measuring, the comparison, the decision making, the issuing of alerts and/or warnings, and any appropriate recommendations. The interface between the PEP Speedometer and the biker would be by any of the following methods: a sound signal; a beep, or a series of beeps, each one meaning a certain thing; a flashing light on the speedometer bezel/face 3609; and/or some icons or symbols or words on the bezel. All this could be mounted on the handle bar or at any other appropriate location.

In addition to all that, we would provide the PEP Water Bottle 3611, together with its PEP Water Nipple 3613 and Cover 3615, which Will be described separately down below. The cover could be made of segments 3615, which can close to protect as in Position R, or open as in Position S in FIG. 37.

Other General Notes re Embodiment #5:

1. Alerting Pedometer, via Earphones, or IPOD, Inside IPOD, with Music,

2. Pedometer signal>>drink from back pack

3. Speedometers Mfrrs: WWW.VDOCYCLECOMPUTING.COM or SPEED ZONE SPORTS.

Embodiment #4-5. Active. The Smart or PEP Water Bottle

Again, see FIGS. 35 and 36.

Now, finally the Smart or PEP Water Bottle itself 3505 and 3611.

A biker or a hiker or most any person exerting large amount of effort doing physical activities expends a lot of body water. If this is not replenished in due time, the person can get dehydrated, a condition that is not very healthy nor desirable.

Many hikers like to carry water bottles with them so that they can drink water every so often on their hikes. Some carry Back Packs with Water Bottles inside the backpack: Some of those are manufactured by CamelBak; Deuter; Kleen Kanteen; etc. Other manufacturers also promote special drinks that are designed to give the hikers or athletes special minerals and other nutrients. Some of these are manufactured by Fast & Light Hydration Bag by www.MSRGear.com; Dromlite; Rapid Energy Fuel, by Hammer Nutrition, Whitefish, Montana; Sports Street Mktg, www.GUsports.com; etc.

Some bicyclists do the same.

Another embodiment of this present invention is the Smart or PEP Water Bottle 3505 and 3611.

In this embodiment, the container of the water would have many of the features mentioned above while describing the smart or PEP pedometer, the smart or PEP wrist watch and the smart or PEP cell phone, as well as the features and capabilities of the PEP-CTS-RSS above.

For water bottles for hikers, they can have at least the features of the pedometer 3501, in addition to the other features. For biker, I guess it would be nice to have the bike send a signal to the embedded chip, informing it about the “distance” and/or “elevation” traveled by the bike.

Then both types of water bottles would also have all the capability of measuring and taking into account the time, the altitude, the atmospheric temperature and humidity, and if possible the body temperature of the person using the bottle. All these measured parameters or vital statistics would then be factored in by the embedded chip and its software/firmware program, and based on previous experience and advice from the medical experts, the system will determine when the person should take a break, how much water should he/she drink and at what intervals, and whether he/she should do some stretching exercises, for example so as not to have cramps, and the like.

In addition, the smart or PEP water bottle would have a way to read, determine and announce the amount of water available in the bottle, and to give proper warnings when the amount of water is low or being depleted or totally gone 3507.

There is a type of water bottle that a person would carry on his back and would drink from it through a tube 3509 that wraps around from the bottle over the shoulder or the side of the person to a point near his mouth. I will call such a bottle arrangement the back pack water bag. Some manufacturers refer to it as the “Camel Back” back pack water bag. An embedded chip 3507 could be built in such a back pack water bag. The back pack would be able to send a vibration signal to the “back” of the person, if and when there is a need to make an announcement or give an alert or warning, and/or to send an audible sound alarm. Or the system can connect to the wrist watch 3503 and provide the signals and announcement on the watch. Or there could be a separate “read-out” for all theses messages. In addition to all that, the smart or PEP water bottle would be able to send messages to a remote monitoring station, which would not only get all these messages, but would also be able to read the GPS location of the person, in case this is an important piece of information desirable for the specific circumstance.

For swimmers, a water bottle or rather a water pouch, can be shaped as a flat double layered bag or pouch that could be strapped to and would conform to the chest or the back of the swimmer. If the swimmer wears a wet suit, then the water pouch could be able to fit inside the wet suit in a way that would still keep the suit “streamlined”. In either case, i.e. with or without a wet suit, the water pouch would be made so as not to appreciably affect the water resistance against the swimmer. It could be strapped at various locations on the body of the swimmer, depending on his/her style of swimming. For example, on the back or to the chest, or behind the neck, or under the chin, or between the legs, etc. I would call such a water pouch, the “Moby Dick” water bag. It would be “instrumented” like the hiker water back pack, with the appropriate PEP devices, as explained above.

Other features that could be included in this and similar embodiments: Replacement water bottle nipple; Water tight nipple, PEP Swimmer Water Bottle; Hiking water bag, to beep, with quantity readout and warning at LOW/Empty; Also the system should have the capability of incorporating the effect of the magnitude of the stride pounding, eg by using an accelerometer, so as to factor it in with the rate and the speed of the person, in order to change the length of work time periods, so that the break period may start earlier if the person has a heavy stride. Also, a “water pedometer” or “stroke meter” could be incorporated. It can be activated by the movements of the arms, the legs, the ankles or even the chest, when any of these swimmers limbs or body parts move or sway or swivel. Even the goggles due to the swaying of the head.

Embodiment #6. Idle. The Smart or PEP Office Chair

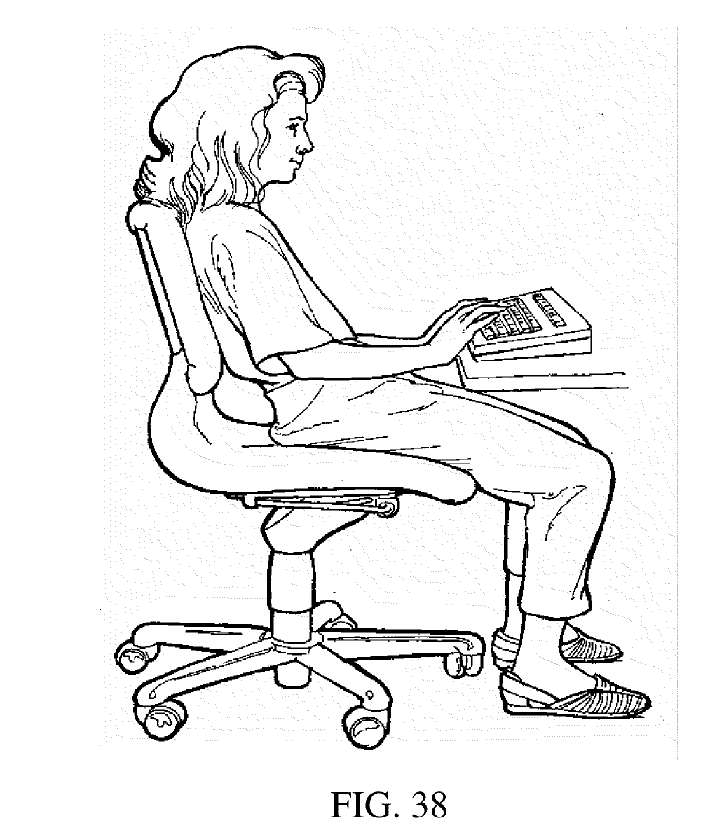

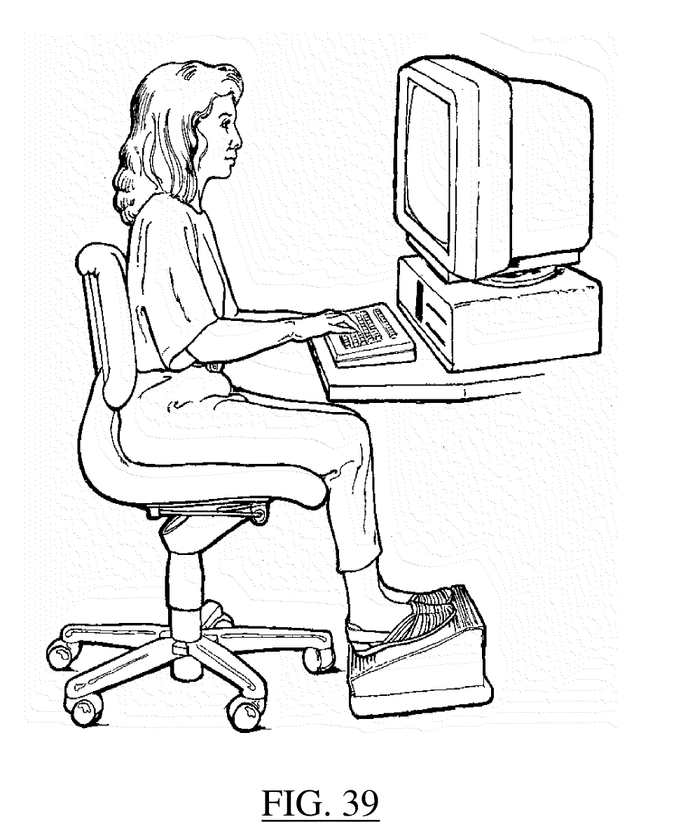

FIGS. 38 and 39 show the incorrect versus the preferred “positions” of an operator sitting on an Office Chair and working at a keyboard, or for that matter, he/she could be working at an assembly table or bench in a manufacturing shop or the like. We can easily provide “sensors” in the chair's bottom cushion of the chair, so that some sensors would be located near the front end of the bottom cushion, some near the back end of the bottom cushion and some more at the middle of the cushion. We can even envision placing some near the right edge of the cushion while some near the left edge and some near the centre.

By sensing the pressure distribution exerted by the operator on these sensors, we can “calculate” “the posture” of the operator, and based on that determine whether he/she is sitting as shown in FIG. 38 or as shown in FIG. 39, i.e. whether he/she is “slouching” or sitting more erect.

Then using a program similar to the CTS RSS described above, we can suggest to the operator to correct his/her posture. Of course, we can still use all the other capabilities of our program, i.e. we can monitor the length of time of work, and recommend break periods and exercises and all what was disclosed above.

Later on, I will disclose also a special embodiment for the “sensors” themselves. See Embodiment #10.

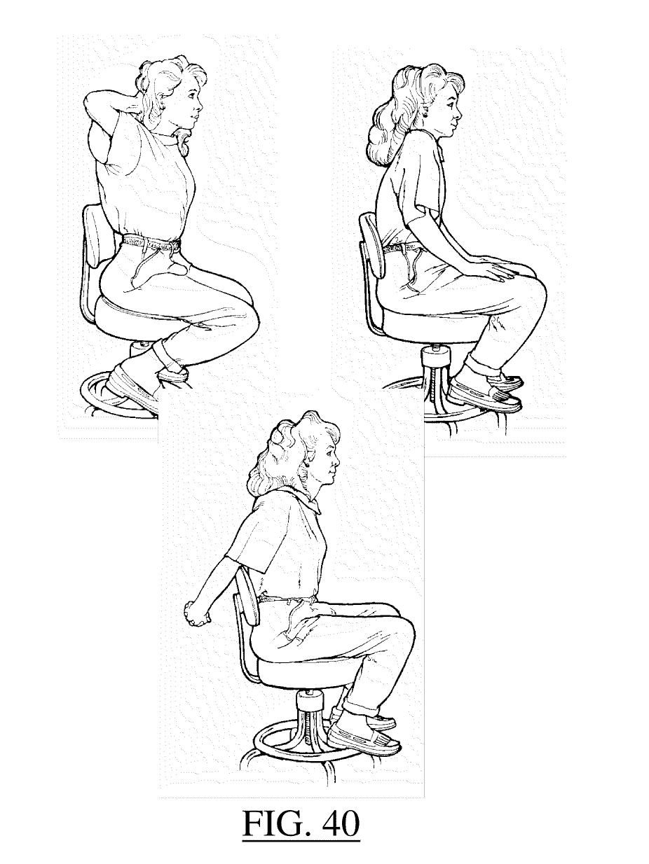

FIG. 40 shows three different “chair” exercises, which are geared towards the upper extremities, especially the shoulders and back. These could be “recommended” by the PEP program, as a special group of exercises, which would be helpful in this situation.

Embodiment #7. Idle. The Smart or PEP Seat or the PEP Sofa

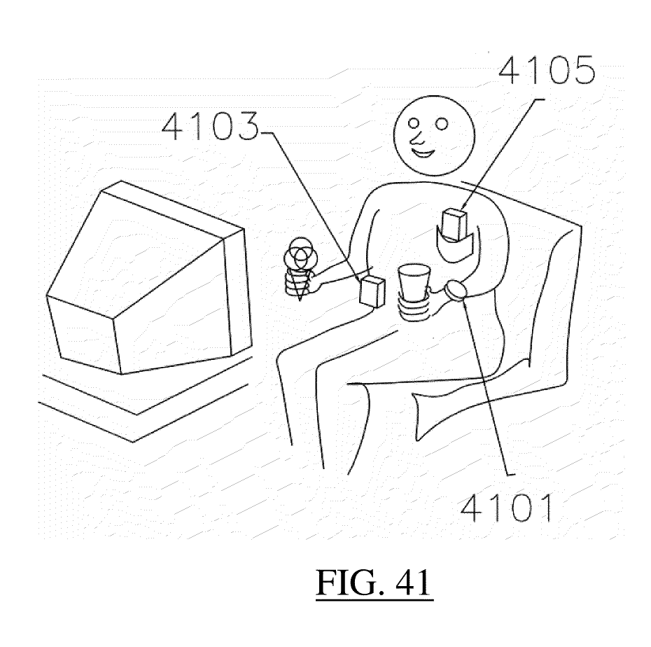

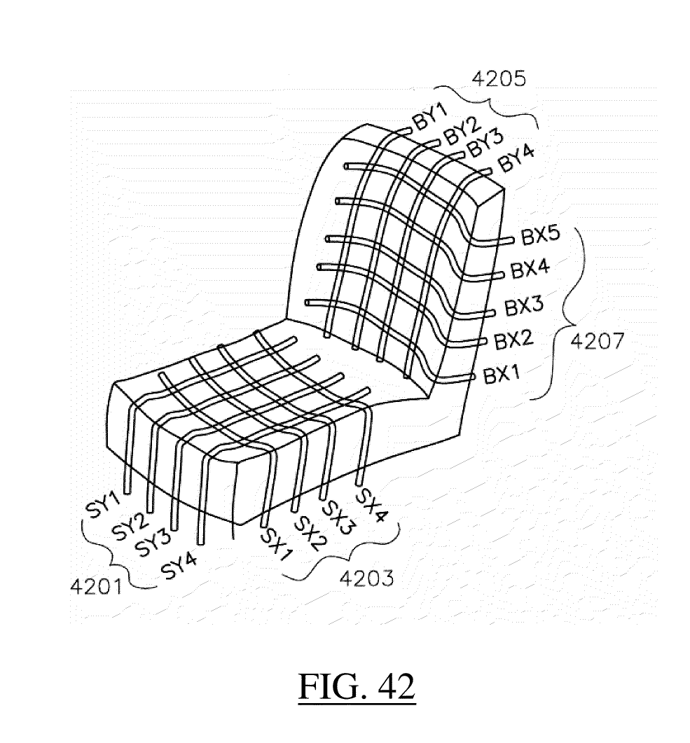

FIGS. 41 and 42. Certain people, especially those with back problems or joint arthritis and the like, feel pain, if and when they stay in one position for long periods of time. Say, if such a person sits a the computer for say over an hour or two, he/she may “gets stiff” and then when the person tries to stand up, he/she feels a lot of pain in his/her back and/or joints. The same thing happens if a person drives his car or truck for long distances and for long periods of time. The problem gets worse, especially if the “Seat” used by that person is “rigid”, i.e. not adjustable. Some cars have “adjustable” Seats, also called Power Seats or Motorized Seats, where say the back can be reclined to different angles, or the Seat base can be tilted up or down, or moved forward or backward. With such adjustable Seats, the effect of long duration usage is reduced, but most of the time it is not totally eliminated.

In cases like these, one or more sensors can be provided within the Seat, either in the base of the Seat and/or the back support of the Seat, which would sense the position of the person sitting on that Seat. I would like to refer to such a seat as the Smart or PEP Seat. The sensors would monitor the position of the person and the time durations the person stays in one position or another, and then would feed back that information to a monitoring computer or an embedded system, or embedded chip or similar device, which in turn would replicate what the computer in the PEP-CTS-RSS— etc embodiment is doing, as described above.

A sedentary person, who loves to watch television for hours on end, and whose joints “gets stiff” and/or suffers from arthritis and the like, would love to have a seat like the Smart or PEP Easy Chair or the Smart or PEP Sofa.

These sensors would be in a way similar to those sensors in many present or new cars, which sense the presence of a passenger sitting on the car Seat. The sensors and related system alert the passenger, or the driver, to buckle up the safety Seat belt. If there is no passenger sitting on the passenger Seat and the seat belt of that seat is not buckled, then the alert signal will not come on and would not sound off for that seat.

The Smart or PEP Seat or PEP Sofa, as per present invention, would have one or more sensors, to “read” the presence, but more importantly, to read the “seating position” of the person sitting on it. If the person has not “shifted” for a long period of time, then the system would alert the person, to either shift and re-arrange the way he/she sits on that Smart or PEP Seat, or Smart or PEP chair or Smart or PEP sofa; or to stand up and maybe take a walk, even if it is only a few steps, to avoid getting the pains and aches that would occur if the person stays in his/her position for longer extended lengths of time.

This can be applied again for car Seats or truck Seats or even office chairs, and more importantly to easy chairs or sofas used when watching television and the like. See FIG. 41.

In FIG. 41, we can see that the Smart or PEP Seat would be able to sense the “inactivity” of the person sitting on it, and if the person does not move enough for any extended length of time, the “box” would let him know. Loud alarm sound, shaking vibrations, or both. This so-called box can be communicating with the Smart or PEP Seat Sensors and computer or embedded system, by wireless, or by wires in less expensive embodiments. The “embedded system” can be within the smart or PEP seat. The “box” can be configured as a “wrist watch” 4101, or as a personal pager 4103 which can be attached say to the belt of the user, or as a pocket gadget 4105, or the like.

The seat will have an X-Y matrix of inflatable tubings, which can be inflated or deflated at will, to “REPOSITION” the pressure points on the driver's body as if the driver has moved his body from one position to another, thus changing the stresses on his joints and muscles.

Similarly, the back support will have a similar, but separate X-Y matrix of inflatable tubings, to do a similar REPOSITIONING on the driver's back.

Other General Notes re Embodiment #7:
1. For athletes, biz men, patients in hospitals, if they are “sedentary”, then get up and move and limber;
2. In the car, announcer to change position in the seat or to stop and take a break or drink, like the Prius Seat Belt. If you don't do what is expected from you, it keeps beeping for a long time. In the Prius, it stops after maybe 2 minutes and does not bother you any more after that, even if you don't put the seat belt on. But with our PEP system, the beep will repeat every certain period of time, e.g. every 5 minutes or so.

Embodiment #8. Idle. The Smart or PEP Bed

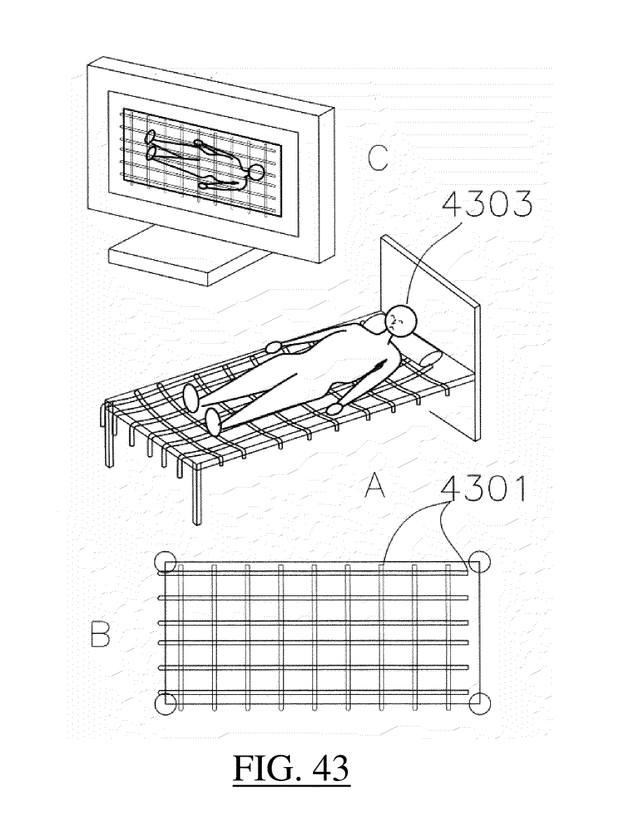

FIG. 43 shows a rough illustration of what I would like to refer to as the “smart or PEP bed”.

The bed would be provided with a number of sensors 4301, not unlike those sensors used in the Smart or PEP Seat. The sensors would be located at strategic locations, so that they would be able to sense the position of a person lying on the bed. I will refer to such a person as the “patient” 4303. If the patient does not move or change his/her position after a certain length of time, it can mean trouble. If the patient is an infant, it could mean a possible infant death syndrome. If the patient is more of an adult, then it could rather indicate that he may not be capable of moving easily by himself and could need help from a caregiver to re-adjust his/her position, otherwise he may contract “bed sores”.

So, again, the bed could send the sensors reading to a computer; central or individual, where the computer would do a similar function as the PEP-CTS-RSS-etc described above, or the smart or PEP bed could have its own “embedded system” to do a similar function. So, once it is determined that the patient has not moved for x length of time, then the system would alert the nurse or care giver of the need to give the patient the proper attention.

In the lower figure “B” of FIG. 43, an X-Y matrix of sensors send their pressure/weight signals to the monitoring program.

In the upper figure “C” of FIG. 43, the monitoring program shows on the computer screen the “pressure impression” of the patient. If the impression does not change after X-number of hours, system alerts nurse, to reposition the patient.

Embodiment #9. The Smart or PEP Massage Seat and the Smart or PEP Massage Bed

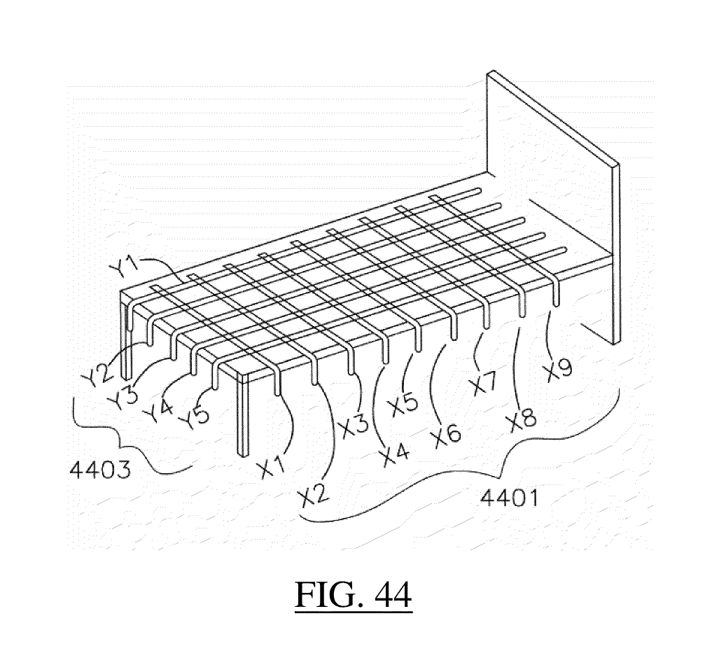

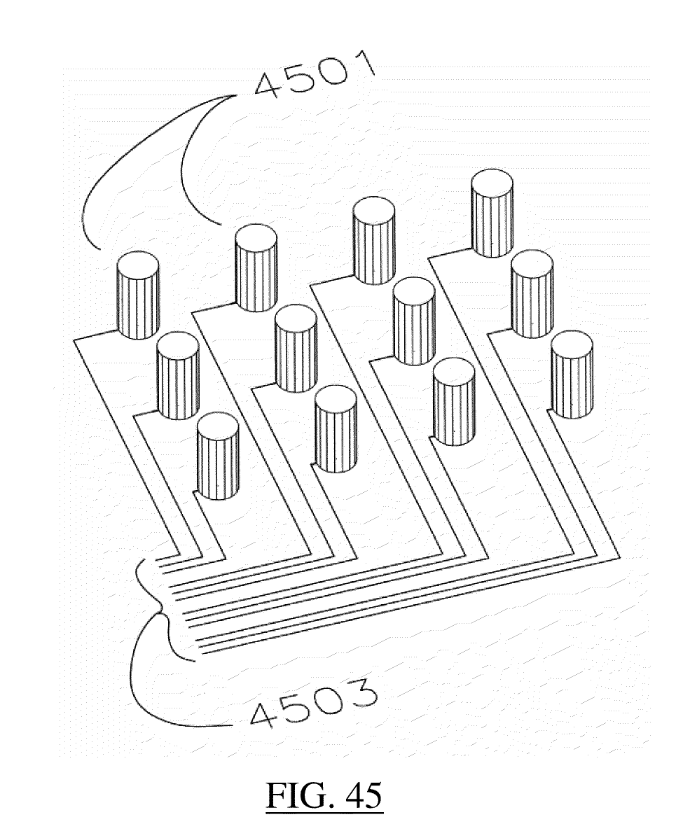

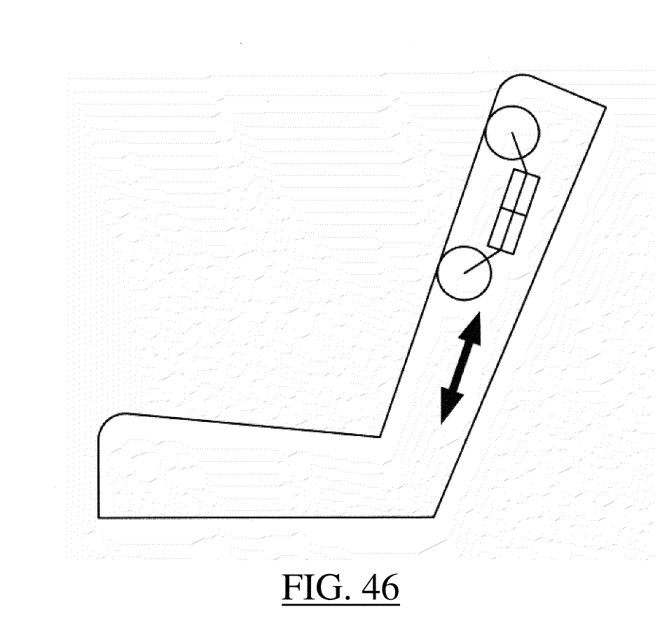

FIGS. 42 and 46 show the Smart or PEP Massage Seat. FIGS. 44 and 45 show the Smart or PEP Massage Bed. Each pair of figures shows two or more different systems which could be used independently or combined together.

Such a bed could be helpful to a patient in a hospital, who lies in bed for hours on end without moving and gets bed sores. And such a seat or chair would desirable for a person who loves to watch television or play video games for long hours, without moving or shifting too often.

FIG. 42 shows a seat with a certain matrix of flexible tubes 4201, 4203, 4205 and 4207, which could be provided either in the seat cushion or in the back cushion, or in both cushions, or even in the side arm rests and along the legs support. The tubes could be identified by calling each one of them as tubes #SY1, SY2, SY3 etc 4201 for the seat tubes in one direction, and as tubes #SX1, SX2, SX3, etc. 4203 for the seat tubes in the orthogonal direction. In the Back cushion, the tubes would be identified as BY1, BY2, BY3 4205, and BX1, BX2, BX3, etc 4207. respectively.

FIG. 44 shows a similar matrix of tubes, which can be applied to a bed. Again they are identified as X1, X2, X3, etc 4401, and as Y1, Y2, Y3, etc 4403.

In both FIGS. 42 and 44, the tubes could be used as the sensors. But more importantly, they can act as means to apply a force and pressure against the body of the person sitting on the chair. By connecting each individual tube to a manifold, with controllable switch valves, then some pressurized fluid, like air, water, oil, etc. can flow to certain specific tubes. By proper selection and control, we can apply more pressure to certain area of the patient's body. So, instead of physically moving the patient from one position to a different position, we can simply change the pressurization of the tubes, so that the areas that were pressurized at one time would be relieved from the pressure at a subsequent time and vice versa, the areas that were free from pressure at one time would now be pressurized and loaded to support the patient's body. This should not be relied upon to do the job for indefinite length of time, but it can reduce the work load burden on the caregivers for a while.

This system can also be considered a new way of applying “massage” to the patient's body.

The tubes can contain hot and/or cold fluids, such as air, water, oils, etc.

The tubes can also be replaced by mechanical and/or electrical devices, which could accomplish similar functions.

The tubes can also act as “sensors” as well as “actuators”, i.e. to provide a lifting force to raise one part of the body or to lower it, depending on what is desired.

FIG. 46 shows a mechanism that has been used in the prior art, to give the user a back massage. This mechanism can be combined/incorporated in the smart or PEP seat shown in FIGS. 41 and 42, to provide an added aspect to the smart or PEP seat.

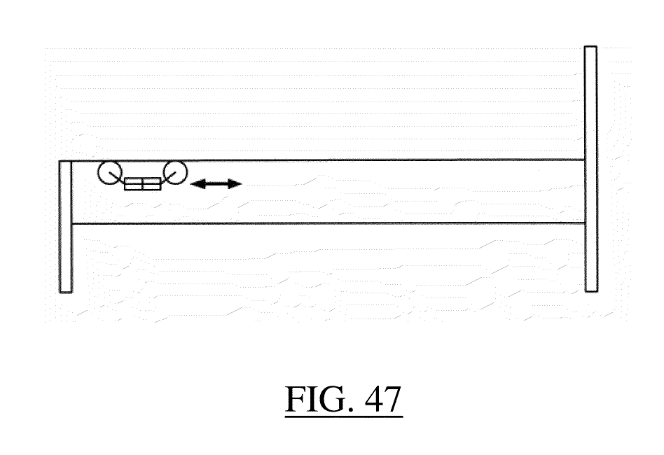

FIG. 47 shows a similar mechanism like the one used in the chair of FIG. 46, but in this case it is suggested to be used in a Bed. Again, this same massage feature could be combined with the Smart or PEP bed shown in FIGS. 43 and 44, again to provide an added aspect to the smart or PEP bed.

Another bed massage system has recently showed up on the market. It is called a water massage bed or something like that. It creates a “pressure wave” that travels from one end of the bed to the other end, usually with some pulsating action. The wave usually moves say from the head end of the bed to the feet end of the bed and then reverses direction. The wave is in straight lines, that are perpendicular to the direction of travel of the wave. The pressure is more or less uniform along each one of those straight lines. In other words, there is no variations in pressure from one end of the line to the other end, i.e. from one side of the bed to the other side. So there is no way to concentrate the pressure on a specific defined spot on one side of the body or the other. In spite of that, such a water bed massager could be “instrumented” as described here, although it would not the full benefits expected from it.

FIG. 45 is a different way to apply and to control the pressure on the patient's body. In this case, the pressure applying devices 4501 are individually controlled and can apply the pressure on a relatively narrower area, than with the flexible tubes or than with the water bed massage. They still will be controlled by the computer or the embedded system, and can be switched on or off individually, so as to either apply the force/pressure at certain times and/or to relieve the pressure purposely.

In a way this is almost similar to the mattresses that are advertised on television, where each half side of the mattress can have a different level of pressurization. In those cases, the presenter advocates to have one half/side pressurized according to the desires of one spouse, while the other half/side according to the desires of the other spouse. But in this case, the whole side of one spouse has the same pressure along the whole area of that side. It is not possible to have, say a higher pressure on the right shoulder and a lower pressure on the left shoulder, for example. All parts of the body will see the same pressure at all time.

With the system described here as per my invention, we could have a high pressure say lifting the right leg and the right shoulder higher while the pressure on the right side of the back and hip is lower, so that the muscles of the right side of the back and hip get relaxed. After a certain length of time, the pressures will be reversed, so that now, the right side of the back and hip will be lifted higher under the higher pressure, while the right shoulder and leg will be relieved from the pressure and relax for a while.

We can even make the pressurized areas smaller, to get even more definition or differentiation in the pressure distribution, as desired.

The number of these “pressure applying devices” 4501 is optional. The larger the number, and the closer they are placed near each other, the more expensive the bed, but there will a bigger latitude to the selection of the areas to be pressurized or deflated and consequently it will be more easy to control which areas of the body to be massaged and which way it will be massaged.

Also, if the patient moves from one part of the bed to a different part of the bed, then the sensors will “reshape” the patient's profile in the embedded system or in the computer, and then the system will determine again whether to reset the pressure or to do whatever is necessary to provide a comfortable rest to the patient and to reset the pressure distribution every preset predetermined periods of time, as described for the PEP-CTS-RSS— etc.

Embodiment #10. The Smart or PEP Chip or Package

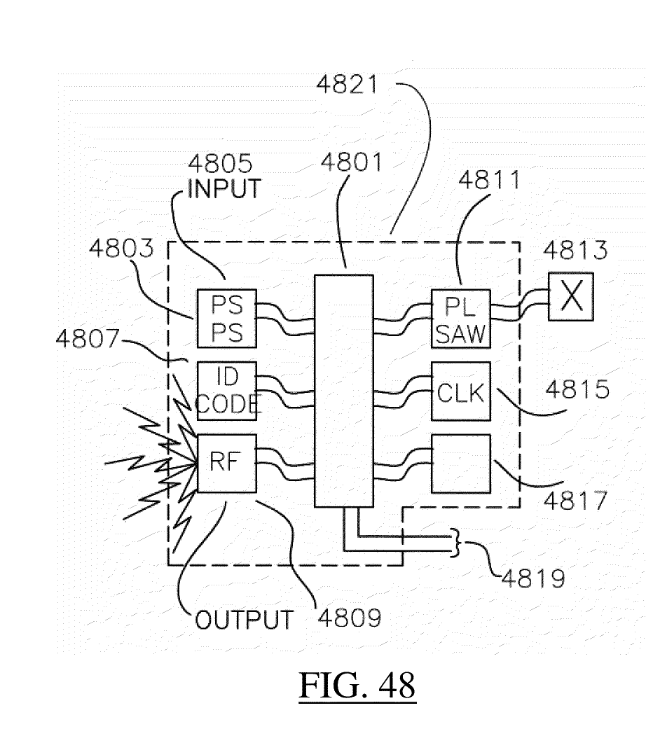

FIG. 48 shows a diagrammatic configuration of an electronic gadget, that I would like to refer to as the Smart or PEP Chip or Package.

In the center of the figure is a rectangular device, which I call the “Embedded Chip with Embedded Firmware” 4801. This will act as the CPU of the PEP System and will perform all the functions as the CPU of the CTS RSS described earlier. Some simplified versions of the PEP Chip or Package will perform only a few of those functions.

Attached to the Embedded Chip, we can see a number of peripheral devices.

To the left, we see the PSPS/Input component 4803. This can be any appropriate input device/component, but it can also be replaced by an external input 4805 coming from an external sensing device, via direct wiring or by wireless. The component shown here is identified as a “PSPS”, which is my abbreviation of “Pressure Sensor & Power Source” combination. This means that the device would sense the pressure applied on it, and at the same time, it could generate some power to run the whole embedded chip. This is similar to some prior art devices called power harvesters. The ones that are used most frequently use the piezoelectric effect to generate certain amounts of electric power to run small electronic chips and the like. In a way, similar to some sneakers that have LEDs that light when the person wearing the sneakers walks with them. So, if we get such a device, say a piezoelectric pressure sensor that would double up as power harvester/generator, then we would kill two birds with one stone. We would get the pressure readings that we want to collect and at the same time, we may not need an additional power source to run our PEP Sensor. But of course, we could use a “PS” only device, i.e. a Pressure Sensor only device, i.e. without the Power Source/Generator and use a small battery cell for the needed power.

Below the PSPS component, I am showing an ID Code component 4807. This would provide an identification to this Smart or PEP Chip or Package and to its output signal that it would send out to any external processing system.

Below that, I am showing an RF Sender component 4809. This would send the signal generated by the Smart or PEP Chip or Package to any external processing system.

To the right of the Embedded Chip, we see at the top a PLSAW component 4811. This means that this component would “sense the power level in the system, and if the power falls to a critical level, then the component will issue an alert and/or warning”.

To the left of that, is an “X” 4813, which indicates that we could possibly have an “optional external power source” 4813. We may need that if the PSPS does not provide all the power needed for the Smart or PEP Chip or Package to function properly.

Below the PLSAW we see the Clock component 4815.

And below that we see the Memory component 4817.

At the bottom of the Embedded Chip we can see some means to interconnect 4819 the chip to the outside world, for programming the chip and for any such other reasons.

All these components and their interconnection pads or terminals, in spite of the fact that they are shown individually and separate from each other, can in fact all be enclosed/integrated inside one electronic chip 4821, that would be designed and manufactured especially for the purpose described here in this specification. It can be made so small that everything would be integral in that chip and would be flat enough to fit under the surfaces of the PEP devices described above.

Such a package can be referred to as a “package” or a “chip” 4821, depending on the way it is manufactured. I could refer to it as the PEP CHIP for short.

So, a Smart or PEP Chip or Package like this one could be inserted in the seat's cushion of the Office Chair, the Easy Chair or Sofa, in the car or truck seats, in the Glove, etc.

We can easily visualize other applications where such a Smart or PEP Chip or Package could be used. For example, the handle of a golf club, a tennis racket, a fishing pole, a walking cane, and so on.

Another potentially large market would be to insert such Smart or PEP Chips or Packages into shoes, sneakers and any other footwear articles, so that they would first act as a “pedometer”, plus in addition, they would measure the magnitude of pressure at different point in the footwear, to help improve any abnormal walking habits or deficiency in the anatomy of the person. An even as interesting application is to insert such chips inside leg or arm prosthesis or braces for amputees, again, first to act as a sort of pedometer or counter, and second to study the pressure distribution and for other similar studies, analysis, and improvements.

We can also incorporate the Smart or PEP Chip or Package into other wearable articles, such as necklaces, ear rings, hair pins, you name it.

Once we embed such a Smart or PEP Chip or Package in any of these articles, then we transform these articles from their original prior art property, to our new “PEP” condition. We would impart to these articles the capability of monitoring the activities of their users, and to measure, compare, decide, issue alerts and/or warnings, and even issue recommendations etc.

Sensors can be shaped as wrist gadget e.g. wrist watch, or as chest sensors, or collars or necklace, or gloves, socks, shoes, ankle bracelets, pedometers

So, this Smart or PEP Chip or Package is KEY to so many various embodiments.

Another version of the Smart or PEP Chip or Package would be one that senses “temperature” instead of “pressure”. Yet another version would be one that senses both temperature as well as pressure. Yet another one would be sensing “humidity”, and so on. Or a combination of these different parameters.

A simplified version of the Smart or PEP Chip or Package would be a similar chip, but without the “decision making” capability. In other words, it would be able to sense the pressures and then send an output to an external decision maker. The output can be by direct wiring, in which case the chip would be almost like any other sensor except for its capability of relying on its own power harvesting, or by wireless, which would be a step above a the former ones.

Of course, the program that will be loaded in the Smart or PEP Chip or Package is a PEP Program.

There are some homes that have a security system that is installed by certain companies specialized in that field of business. Let's refer to such a company as the “ADT” Security Systems Co. If and when there is any sort of an emergency, the security system installed in the house would telephone the security company ADT and would “inform” ADT about what is wrong, e.g. a window pane has been broken or water is leaking in one of the rooms. ADT then quickly takes whatever necessary corrective action that would minimize the damage. Similarly, with this our Smart or PEP Chip or Package, it can be wired and/or programmed to do a similar function. For example, if it is fitted inside that heart rate strap of an elderly person, and if the heart beat rate is dangerously irregular or out of the norm, the Smart or PEP Chip or Package could alert the equivalent of ADT, who in turn would either alert a medic or take the necessary action themselves.

Embodiments #11+. Miscellaneous Smart or PEP Gadgets incorporating the PEP Embedded Chip

Pedometers or Pressure sensors can be incorporated into a lot of products, to impart to these products the ability to act as the products described in the previous embodiments. For example they can be incorporated into such products as: Sunglasses, Sneakers, Ski Poles, Golf Clubs, Golf Clubs Carts/Cadies, Golf Cart, bikes pedals, bikes seats, (in the bike itself as a Speedometer), belts or belt buckles, or to be attached to the belt eyelets in the pants, bike helmet; bike seat; bike handle grips or grips replacements; tee-shirts; clothing; hats; skis; etc. etc.

General Notes re Embodiments #11+:
1. “Options” should also include: Open, Save, & Maintain a Log File.
2. A friend of ours cannot sit in a chair for a couple of hours continuously, she says, because due to her severe arthritis, if she did that, she would not be able to get up at all. She should stay in that one position for a much shorter time. How, when I suggested that she should stand up and walk around, say every 10-15 minutes, she said: “Oh, no! She would never do that, in consideration to the people sitting around with her.”
3. Cell phones could be used to act as Read-Outs for the PEP Gadgets.
4. The End Users of our PEP CTS Systems and products are the Employees or the individual worker/operator. The Buyers are mostly the big employers, or the individual operator in small businesses or private parties working at their home or for pleasure.
5. Our devices and systems can be installed in bikes, motorcycles, airplanes, office chairs, etc.
6. In cars and trucks, motorcycles etc: they could be used for sensing the road travel, sensing the seat bottom and/or seat backs for movements, like the Toyota Prius sensing the passenger seat for seat belt warning, and then physically moving the seat and/or back in different positions if the driver does not do it himself.
7. They could be used inside &/or with the “TENSE” systems, the pain control gadgets.
8. Inside Ear phones, Cell Phones,
9. To limit time on cell phone.
10. On phones, regular land phones or cell phones, to limit the length of the calls times, move the phone from one ear to the other ear, flex the neck and fingers.
11. On the computer and the like: Include an ALARM CLOCK Feature/Function, to stop working at fixed times during different days, selecting effective days, with a spreadsheet-like calendar and setting dialogue windows.
12. Patients in wheel chairs: drinking water, seating pressures, flexing and stretching exercises, . . .
13. Smart Wrist Pad.
14. Video Games hand controls and control sticks and the like.
15. In a vehicle, a PEP Chip or Package could also sense the “road conditions”, i.e. smooth or bumpy, and factors-in the undue stress on the driver and/or passengers, to shorten or lengthen the time to drive before a break period would be recommended.
16. A similar PEP Chip or Package could be incorporated in hand controls of video games and the like.

I claim:

1. A system for monitoring the behaviour of a person and comparing it with certain desirable or safe conditions and with certain undesirable or unsafe conditions, wherein if the actual behaviour reaches a level close to or exceeds the undesirable conditions, then the system would provide indications, signals and possibly suggestions, for the person, to alter his/her behaviour so as to reduce/minimize the potential detrimental effects, which could result if the original/actual behaviour would continue unchanged or unchecked.

2. A system as in claim 1, wherein
said system comprises
a) a sensing means capable of
b) sensing the behaviour or activities of the person and/or the elements of said behaviour, and the physical conditions of the person, during his/her active period of time, which will be referred to as the “work period”, and
c) collecting and translating these sensed elements into data that can be used by a comparison device, such as a computing device or computing chip;
d) means of sending the sensed data from the sensing means to the comparison device,
e) a comparison device, capable of receiving the sensed and collected data,
f) an algorithm or a software program capable of controlling the comparison device so that it would manipulate the sensed data and compare them against a set of preset predetermined levels and limits of said behaviour, and to determine and to make proper conclusions and decisions as to whether the sensed behaviour is reaching, or has already reached, those undesirable or unsafe levels and limits, and
wherein
g) when the system detects that the person's behaviour has reached the undesirable or unsafe preset levels or limits, then the system would issue signals, so that the person would become aware and would have the option of changing his/her behaviour, e.g. by taking a “rest period” to prevent the person from hurting himself or herself, and wherein
h) the system could also suggest certain new activities, during the rest periods or otherwise, to counteract the ill effects of the original activities.

3. A system as in claim 2, wherein
the monitored or sensed behaviour or activities of the person is any one or a combination of one or more items or “acts” from the following group:
a) operating a computer or just sitting in front of a computer,
b) sitting in front of a television set,
c) sitting on a chair or sofa,
d) lying down on a bed or sofa,
e) driving a car,
f) riding a bicycle,
g) operating a motorized jack hammer,
h) doing various physical exercises, such as swimming, walking, lifting weights and the like.

4. A system as in claim 2, wherein
the sensed behaviour elements or the physical conditions of the person is any one or a combination of one or more items or “activity elements or characteristics” from the following group:
a) the duration or length of time that the person is doing any one of the monitored activities;
b) the intensity and level of energy exerted during these activities;
c) the physical conditions of the person, such as body temperature, the heart pulse rate, the eye blinking rate, the size of the eye pupils, the blood pressure, blood sugar level, blood alcohol level, etc. of the person, or even
d) the emotional status of the person.

5. A system as in claim 2, wherein
the sensing means can be any one or a combination of one or more of the items from the following group:
a) a sensor or an embedded algorithm built into the keyboard or the mouse of a computer or programmed into the electronic components of the computer to monitor and count the number of mouse clicks or keyboard strokes and their speed and intensity;
b) a “presence” sensor and “condition” sensor such as a pressure sensor built into the chair or seat or sofa or bed carrying the person, or built into an office chair, a car seat or a bicycle or motorcycle seat, to determine the presence and seating position of the person;
c) incorporated into a glove that the person would wear on his hand, or in the handle of a golf club, or in the steering wheel of a car, for detecting the articulation of the fingers and of the wrist etc, and/or the intensity of his grip and/or the intensity and number of stroke or hits exerted say from a golf club or a mechanical jack hammer or from the vibration of the steering wheel, and their effects on his hand and wrist;
d) a thermal probe attached to the body of the person to determine say whether he will contract hypothermia or will get a heat stroke;
e) a photo cell to detect the size of the eye pupil or the rate of eye blinking to detect whether he is falling asleep at the wheel;
f) a simple counter like a pedometer, which would count the number of walking steps or the number of repetitions of a certain activity; and the like; in other words, an appropriate sensing device for each of the various activities and physical conditions listed above, which the system is designed to monitor and control.

6. A system as in claim 2, wherein
the comparison device can be any one or a combination of one or more of the items from the following group:
a) a sensor or an algorithm built in/embedded into the keyboard or the mouse of a computer;
b) built in or programmed into the electronic components of the computer itself, to watch for potential causes of carpal tunnel syndrome and the like;
c) a simple temperature measuring and differentiating device, similar to a thermostat;
d) a counter or a timer to compare the actual number of repetitions that have already taken place;
or
e) the elapsed time duration of a certain activity; against the preset predetermined count or time, preset in advance;

7. A system as in claim 2, wherein
the collecting and translating the sensed elements into data can be accomplished by any one or a combination of one or more of the items and/or methods from the following group:
a) a simple mechanical or electrical or electronic counter can collect say the number of clicks on the computer keyboard or mouse;
b) a mechanical or electrical pedometer can count and collect the number of steps that the person has taken during a certain hike up a mountain trail or during his/her work in the office or at home;
c) these counters could show the “total counts” in a simple window like the inexpensive mechanical pedometers, or
d) translate the total counts to an electrical or electronic signal that the computing device can utilize; in order to accomplish the rest of the process;

8. A system as in claim 2, wherein
the means and acts of sending the sensed data from the sensing means to the comparison device can encompass any one or a combination of one or more of the devices in the following group, and the act of sending the data can be accomplished by any one or a combination of one or more of the methods from the following group:
a) in a simple mechanical pedometer the data is sent by the mechanical components, e.g. gears, levers, etc. inside the pedometer mechanism from the mechanism directly to the “readout window” which shows the number of steps taken;
b) in a more complex monitoring system, the system elements could be “hard wired” together, so that the data would be sent directly from the “sensors” to the comparison device; or
c) the data could be sent by “wireless”, using say short distance wireless communications means, such as “Bluetooth” technology”, say between a sensor glove and the computer chip that will process the data further.

9. A system as in claim 2, wherein
the comparison device can encompass any one or a combination of one or more of the devices in the following group:
a) a computer or a computer chip, say for the number of clicks on the keyboard or the mouse;
b) a tripping mechanism for the pedometer, similar to the electro-mechanical timers used to turn on and off Christmas tree lights;
c) a bimetal strip with corresponding contact points, like the conventional home thermostat to compare the temp of the person's body against the preset temp limit;

10. A system as in claim 2, wherein
the algorithm or software program can encompass any one or a combination of one or more of the items in the following group:
a) a mathematical algorithm or software prepared for the specific computer or the computer chip, and which could be “installed” in the individual stand-alone computer, or embedded in the computer chip or in the glove say; or
b) if the computer is a part of a network, then the software could be installed in the central server of the network and then the individual “satellite” computers would be utilizing this central software to accomplish their intended operations, i.e. to manipulate the data and to control their process; or
c) the software could be pre-packaged and stored on a memory device, like a CD disk and sold to the individual users, to be installed on their individual computers;

11. A system as in claim 2, wherein
the preset predetermined levels and limits of said behaviour and behaviour elements can encompass any one or a combination of one or more of the items in the following group:
a) a simple preset predetermined time duration for a specific activity, say 55 minutes of working on a keyboard, regardless of the number of clicks, or say if the patient has been lying in bed in one position for three or four hours without changing that position; or
b) the total number of events, without regard to the time it takes to reach that number, such as the number of clicks on the keyboard, say 3,000 clicks; or to include the clicks on the mouse in addition to the clicks on the keyboard; or say 1,000 steps on the pedometer; or
c) a combination of number of events together with the time duration, such as number of clicks accomplished in a certain length of time, so that if the speed is high then the total length of time allowed would be shorter, and/or to include into consideration the “intensity” of the specific activity and/or the magnitude of the effort exerted by the person;

12. A system as in claim 2, wherein
the combination of the algorithm or software program and the comparison device will give the system the capability of manipulating the collected data and of comparing them against the preset predetermined levels and limits,

13. A system as in claim 2, wherein
the signals issued by the system can encompass any one or a combination of one or more of the items in the following group: I) Warning Signals, such as
a) an audible sound, which can be continuous or intermittent and/or could have different sound (decibel) levels or tones;
b) a visible light indication, which can be continuous or blinking or can have different colours or change in intensity according to the severity of the situation, i.e. the magnitude of the difference between the actual conditions and the preset limits;
c) a vibration signal, like on some cell phones; or the like; or II) Action Signals, such as
d) Raise a flag,
e) inform the user that the system will shut down the computer; or
f) physically shut down the system/computer, either for a certain length of time, or totally shut down the whole computer, maybe after saving any open files and the like.

14. A system as in claim 2, wherein
the suggested new activities can encompass any one or a combination of one or more of the items in the following group:
a) simply rest and do nothing for a certain preset predetermined length of time;
b) suggest to the operator to do certain exercises, which are intended to counter-act the ill effects of the previous activity, for example, to flex the hand, wrist, fingers, knuckles, elbows, shoulders, i.e. the upper extremities, in any way just to limber and reduce the stiffness, or to do a certain “routine” to accomplish a similar end result;
c) suggest similar exercises, but for the back or for the lower extremities or for the whole body;
d) change the suggested set of exercises every “period”, i.e. at the end of the first work period, flex and exercise the upper extremities, then at the end of the second work period, flex and exercise the lower extremities, and then at the end of the third work period, go back to the same exercises of the first work period, i.e. flexing the upper extremities, and so on;
e) change the suggested exercises at the end of every work period;
f) keep certain suggestions all the time, i.e. at the end of every work period, as “base” exercises and then attach to those base exercises a variety of other exercises that would vary with each work period.

15. A system as in claim 2, wherein
the duration of the “work periods” and the duration of the “rest” periods could vary based on a preset predetermined plan, which could be modulated based on the type and nature of the original activities of the person, for example, the work period can be 55 minutes and the rest period can be 5 minutes, or they can be 45 and 15 minutes respectively or they can be 95 and 2 minutes respectively or any other combination that would be deemed desirable or effective for the intended purposes and wherein the individual durations do not have to be repeated exactly the same way all the time every cycle.
